(19) United States
(12) Patent Application Publication
(10) Pub. No.: US 2024/0291292 A1
(43) Pub. Date: Aug. 29, 2024

(54) MULTIPLEXING SYSTEMS FOR BATTERIES OF ELECTROCHEMICAL CELLS

(71) Applicant: Sion Power Corporation, Tucson, AZ (US)

(72) Inventors: Yuriy V. Mikhaylik, Tucson, AZ (US); Wenzhuo Yang, Tucson, AZ (US); Kyle Robbins Van Wig, Tucson, AZ (US)

(73) Assignee: Sion Power Corporation, Tucson, AZ (US)

(21) Appl. No.: 18/589,152

(22) Filed: Feb. 27, 2024

Related U.S. Application Data
(60) Provisional application No. 63/487,422, filed on Feb. 28, 2023.

(51) Int. Cl. H02J 7/00; H01M 10/44

(52) U.S. Cl. CPC H02J 7/0019; H01M 10/441; H02J 7/0048; H02J 7/0063; H01M 10/445; H01M 2220/20

(57) ABSTRACT

Multiplexing systems for batteries of electrochemical cells and associated methods are generally described. Multiplexing systems may be used to improve certain properties of electrochemical cells, such as cycle life and/or safety, during cycling of the battery, according to some embodiments. For example, in some embodiments improvements in electrochemical cell and/or battery performance are provided that are associated with management of charging and discharging of electrochemical cells by the multiplexing system.

### RELATED APPLICATIONS

This application claims priority under 35 U.S.C. § 119(e) to U.S. Provisional Patent Application No. 63/487,422, filed Feb. 28, 2023, and entitled, “MULTIPLEXING SYSTEMS FOR BATTERIES OF ELECTROCHEMICAL CELLS,” which is incorporated herein by reference in its entirety for all purposes.

### TECHNICAL FIELD

Electrochemical cell management systems and associated methods are generally described.

### BACKGROUND

Dendrite formation is an undesirable phenomenon in some electrochemical cells—particularly, lithium-containing cells—that can result in failure of the electrochemical cells and that can pose a serious safety hazard. Dendrite formation occurs during charge-discharge cycling of the electrochemical cells. Electrochemical cell performance may be improved by reducing dendrite formation during charge-discharge cycling.

### SUMMARY

Multiplexing systems for batteries of electrochemical cells and associated methods are generally described. Multiplexing systems may be used to improve certain properties of electrochemical cells, such as cycle life and/or safety, during cycling of the battery, according to some embodiments. For example, in some embodiments improvements in electrochemical cell and/or battery performance are provided that are associated with management of charging and discharging of electrochemical cells by the multiplexing system. The subject matter of the present disclosure involves, in some cases, interrelated products, alternative solutions to a particular problem, and/or a plurality of different uses of one or more systems and/or articles.

In one aspect, an electrochemical cell management system is provided. According to some embodiments, the electrochemical cell management system comprises: two or more electrochemical cell sets; a multiplexing switch apparatus; and at least one controller configured to: compare a power demand to a threshold power demand; and in response to determining that the power demand is below the threshold power demand, use the multiplexing switch apparatus to selectively discharge the sets.

In another aspect, an electrochemical cell management method is provided. According to some embodiments, the method comprises: comparing a power demand of a system comprising two or more electrochemical cell sets to a threshold power demand; and in response to determining that the power demand is below the threshold power demand, using a multiplexing switch apparatus to selectively discharge the sets.

Other advantages and novel features of the present disclosure will become apparent from the following detailed description of various non-limiting embodiments of the disclosure when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present disclosure will be described by way of example with reference to the accompanying figures, which are schematic and are not intended to be drawn to scale unless otherwise indicated. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIG. 1 is a block diagram illustrating a representative battery management system, according to some embodiments.

FIG. 2 is a discharge/charge-time graph for a representative electrochemical cell management system, according to some embodiments.

FIG. 3 is a flow chart depicting a representative process for managing electrochemical cells, according to some embodiments.

FIG. 4 is a flow chart depicting an additional representative process for managing electrochemical cells, according to some embodiments.

FIG. 5 shows a cross-sectional schematic diagram of a battery comprising electrochemical cells, a lateral support component, and a housing, according to some embodiments.

FIG. 6 shows a cross-sectional schematic diagram of an electrochemical cell, according to some embodiments.

FIG. 7 shows a cross-sectional schematic diagram of an electrochemical cell, according to some embodiments.

FIG. 8 shows a cross sectional schematic diagram of an electric vehicle comprising a battery, according to some embodiments.

### DETAILED DESCRIPTION

The inventors have recognized and appreciated that conventional techniques for management and operation of rechargeable electrochemical cells have resulted in the previously poor longevity and performance of cells (and batteries in which they may be included). For example, cells have suffered a short cycle life (e.g., a low number of complete cycles before capacity falls below 80% of original capacity, as cells typically do at some point after sufficient usage), particularly where charge and discharge rates are similar, or where the charge rate is higher than the discharge rate. For example, many users of cells in batteries have desired the batteries to have nearly identical charge and discharge rates (e.g., 4 hours to charge and 4 hours to discharge), and battery manufacturers have provided batteries and battery management systems that provide such nearly identical rates. Many users have also desired batteries to charge at higher rates than they discharge (e.g., 30 minutes to charge and 4 hours to discharge) for various reasons, such as to reduce inconvenience of waiting for charging to use the batteries and extended runtimes.

The inventors have recognized and appreciated that the cycle life of a cell (and a battery including the cell), and consequently the longevity and performance of the cell (and battery), may be greatly improved by employing higher ratios of discharge rate to charge rate, higher ratios of charge rate to other charge rate(s) (such as a preceding or proceeding rate(s)), and/or higher ratios of discharge rate to other discharge rate(s). Furthermore, the inventors have recognized and appreciated that these ratios may be employed by providing a cell and/or battery management system that controls the cell or cells to provide such ratios.

Some embodiments, such as embodiments having multiple cells, are directed to a battery management system that multiplexes cells such that the cells can be charged all at once (or with multiple cells discharged at the same time) and discharged individually or in smaller sets. This may result in actual ratios of discharge rate to charge rate (or discharge rate to other discharge rate(s), or charge rate to other charge rate(s)) for the cells that improve their cycle life, while providing whatever output rates that are desired or required for particular loads and applications. Furthermore, the inventors have recognized and appreciated that discharging some but not all of the cells at once with homogeneous current distribution may also improve their cycle life.

For example, with a battery having 4 cells, 1 cell could be discharged at a time at 0.5 amps for 3 hours each (e.g., each cell being discharged separately and sequentially, with each discharging for 3 hours, to discharge all 4 cells over 12 hours), and then all 4 cells could be charged together at 0.5 amps for 12 hours (e.g., the separate discharging is followed by a charging step where all 4 cells are charged together, providing a 0.5 amps in aggregate but closer to 0.125 amps for each cell individually)—such a configuration would provide an actual ratio of discharge rate to charge rate of 4:1, while the ratio from the user's perspective would be 1:1 because the cells are discharged individually for 3 hours each (totaling 12 hours of discharge time). The inventors have recognized and appreciated that such a battery management system may actually improve the cycle life of batteries while still providing users what they desire or need from the batteries. In some embodiments, the functionality providing this duo of benefits may be hidden from users and may be integrated into the cell blocks and/or batteries themselves.

The inventors have also recognized and appreciated that cell-multiplexed charging and/or discharging may be employed more advantageously where the use or extent of multiplexing is dependent on the expected power draw from the system on the battery. For example, where at least a threshold amount of power is demanded from a battery, the need to quickly discharge a large number of cells may render cell-multiplexing unnecessary or even inhibitive to meet the power demand. On the other hand, where less than the threshold amount of power is demanded from the battery, cell-multiplexing may be advantageously employed to increase the rate of discharge of the individual cells, which can improve the cycle life of cells of the battery as opposed to if no cell multiplexing were used below the threshold power demand.

Some embodiments are directed to a battery management system including a multiplexing switch apparatus and at least one controller configured to compare a power demand to a threshold power demand. For example, the controller may be configured to receive the power demand from a device receiving power from a battery. In response to determining that the power demand is below the threshold power demand, the controller may be configured to use the multiplexing switch apparatus to selectively discharge sets of battery cells. For example, the controller may be configured to selectively discharge cells according to one or more criteria relating to a predefined sequence of cells and/or context-sensitive determinations, such as the duration of the load connection and/or charge capacity at the load connection. In response to determining that the power demand is at or above the threshold power demand, the controller may be configured to discharge the sets of battery cells without multiplexing. For example, the controller may be configured to discharge each and/or a predefined set of battery cells in a manner that bypasses the multiplexing switch apparatus, such as using dedicated connections to each or the aggregate of such cells.

It should be appreciated that, in a system configured to use a multiplexing switch apparatus to selectively discharge cells at but not above a particular power demand level, the threshold power demand referred to herein may be defined above that power demand level.

Furthermore, the inventors have recognized and appreciated that analysis and control as described further herein may be performed by a cell and/or battery management system employing such a controller.

The term “charging step” is used herein to generally refer to a continuous period of time during which charging is performed without discharging, and the term “discharging step” is used herein to generally refer to a continuous period during which discharging is performed without charging. A charging step coupled with a discharging step may form a cycle, but the cycle may not necessarily be a complete cycle.

The term “capacity” is used to generally refer to an amount of electrical charge a cell or cells can deliver at a given or rated voltage and is often measured in amp-hours (such as milliamp-hours or mAh). In some embodiments, capacity may be the mAh a cell or cells can hold at a given point in time (which may change over multiple cycles), it may be the mAh remaining in a cell or cells at a given point in time, or it may be the mAh a cell or cells need to fully re-charge.

The term “state of charge” (SOC) is used herein to refer to a level of charge of the cell relative to its capacity and is measured as a percentage. As examples, a state of charge of 100% refers to a fully charged cell, a state of charge of 40% refers to a cell that retains 40% of its capacity, and a state of charge of 0% refers to a fully discharged cell.

The term “state of charge range” (SOC range) is used herein to refer to a range of states of charge. For example, a state of charge range of 10% to 50% would include the states of charge of 10%, 50%, and all states of charge between 10% and 50%.

The “breadth” of the state of charge range is used herein to refer to the absolute value of the difference between the end points of a state of charge range. To illustrate, a state of charge range of 10% to 50% would have a breadth of 40% (because 50% minus 10% is 40%). As another example, a state of charge range of at least 2% and at most 5% would have a breadth of 3% (because 5% minus 2% is 3%).

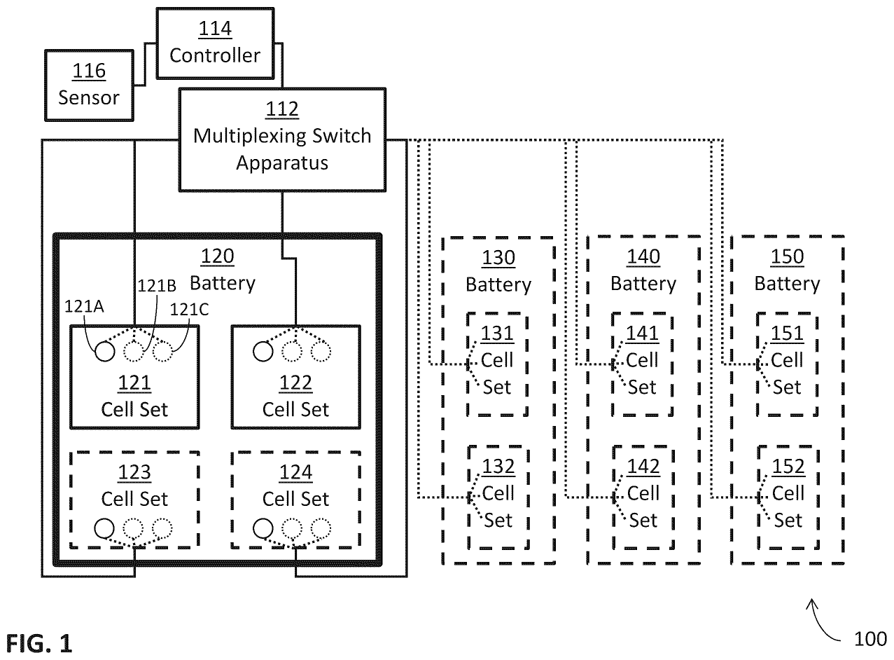

FIG. 1 depicts a representative battery management system 100. In some embodiments, such as embodiments having multiple cells, representative system 100 may include a multiplexing switch apparatus (e.g., 112), a controller (e.g., 114), one or more sensors (e.g., 116), and one or more batteries (e.g., 120, 130, 140, 150, and so on). It should be appreciated that although only a single multiplexing switch apparatus 112, controller 114, sensor 116, and only four batteries 120-150 are shown in FIG. 1, any suitable number of these components may be used. Any of numerous different modes of implementation may be employed. Furthermore, although a label in the singular is used herein to reference a multiplexing switch apparatus, it should be appreciated that the components used for the multiplexing and switching described herein may be distributed across any suitable number of devices (e.g., switches).

The battery or batteries (e.g., 120-150) may respectively include one or more cell sets (e.g., 121-124, 131-132, 141-142, 151-152, and so on), referred to also as sets of cells. In some embodiments, two or more sets of cells are included in each battery, such as 121-122 and so on. Additionally, each set of cells (e.g., cell set 121) may include one or more cells (e.g., 121A-121C). In some embodiments, each cell (e.g., 121A) may include at least one lithium-metal electrode active material. Additionally, each set of cells (e.g., cell set 121) may include one or more cells (e.g., 121A-121C). In some embodiments, each set of cells may have a single cell. Alternatively, each set of cells may include multiple cells and may form a cell “block,” or multiple sets of cells may together form a cell block. Additionally, each cell (either in a battery, all the batteries in a battery pack, or in a set of cells) or set of cells may utilize the same electrochemistry. That is to say, in some embodiments, each cell may make use of the same anode active material and the same cathode active material.

In some embodiments, a multiplexing switch apparatus (e.g., 112) may include an array of switches. Additionally, the multiplexing switch apparatus may be connected to each set of cells and/or to each cell individually. In some embodiments, the controller, such as 114, may use the multiplexing switch apparatus to selectively discharge the cells or sets of cells (e.g., not all of the cells or cell sets in the battery, but a subset of them) based on at least one criterion.

For example, the criterion may include a sequence in which to discharge the cells or sets of cells, such as a predefined numbering or order associated with the sets of cells (e.g., starting with a first set, switching through each set to the last set, and then starting over with the first set), and/or an order based on the cell(s) or set(s) of cells with the next highest voltage or some other measure indicating the next strongest. The inventors have recognized and appreciated that using a sequence, especially a predefined numbering, may reduce the complexity of the operations performed by the system (e.g., a controller that is not a microprocessor) and may be usable by a wider array of systems.

Alternatively or additionally, the criterion may be context-sensitive, such as by considering any one or more of the following: a duration of a connection between a load and a set of cells currently connected to the load (which may be at least 0.01 seconds in some embodiments), a delivered capacity at the connection, and the value of a function having one or more parameters. In certain embodiments, the criterion may not include a number of prior discharging steps of the set of cells.

In some embodiments, the function may have parameters such as any one or more of the following: a capacity accumulated over several connections between the load and the set of cells, the delivered capacity at the connection, a current of the set of cells, a voltage of the set of cells and/or of at least one other set of cells, a cutoff discharge voltage of the set of cells, a power of the set of cells, an energy of the set of cells, a number of charging or discharging steps of the set of cells, an impedance of the set of cells, a rate of voltage fading of the set of cells during the connection, a temperature of the set of cells, and a pressure of the set of cells (e.g., the pressure on the cell(s) from their physical enclosure, which may indicate cell capacity and is discussed further below). According to some embodiments, the delivered capacity at a single connection may be in the range from 0.01% of nominal capacity to 100% (e.g., 95%) of set nominal capacity.

In some embodiments, a sensor (e.g., 116) may measure the criterion and/or any of the parameters of the function. For example, the sensor may include a current sensor that measures the current in amperes of a given set of cells. It should be appreciated that the criterion may be plural or singular and may relate to the currently discharging set of cells and/or may determine the next set of cells.

In some embodiments, the controller (e.g., 114) may include one or more processors, which may be of whatever complexity is suitable for the application. Alternatively or additionally, the controller may include an analog circuit and/or a less complex logic device than a processor or microprocessor. For example, evaluating the function of the criterion in some embodiments may rely on a microprocessor forming part or all of the controller.

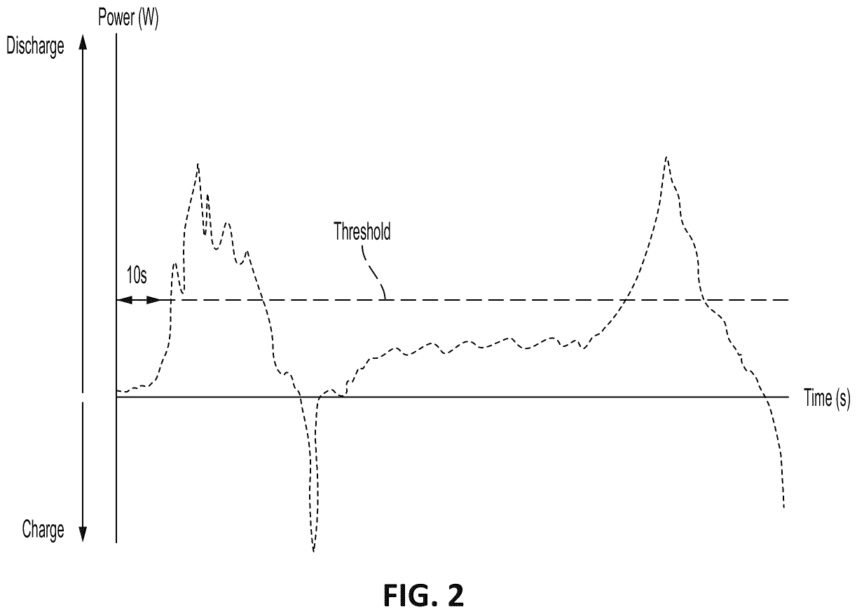

FIG. 2 depicts a discharge/charge-time graph for a representative electrochemical cell management system, according to some embodiments. In FIG. 2, the vertical axis shows discharging power in the positive direction and charging in the negative direction. The dashed line in FIG. 2 indicates an exemplary threshold. In some embodiments, the controller may engage and/or disengage from using the multiplexing switch apparatus depending on the expected power draw of the system. For example, the controller may compare a power demand to a threshold power demand (such as is shown in FIG. 2) and engage and/or disengage from using the multiplexing switch apparatus in response to the comparison. In some embodiments, the controller may receive the power demand from a device connected to the battery to receive power therefrom. For example, the power demand may be in the form of a digitally encoded message from a computer onboard the device. In some embodiments, the power demand may correspond to an amount of power requested by the device, such as in the form of a power demand request. As one example, where the device is onboard a car, the power demand may, at one time, correspond to the amount of power needed to accelerate the car in response to a driver of the car pressing on the accelerator pedal. In this example, the power demand may, at another time, correspond to the amount of power needed to operate the car in an idling state with the accelerator pedal not being pressed.

In some embodiments, the controller may, in response to determining that the power demand is below the threshold power demand, use the multiplexing switch apparatus to selectively discharge the sets of cells, such as described further herein. For example, various programmable discharging rates may be used, and/or one or more criteria may be used to determine the discharging rate and/or which sets of cells to discharge. In some embodiments, in response to determining that the power demand is at or above the threshold power demand, the controller may discharge the sets of cells without multiplexing. For example, rather than selectively discharging the sets of cells, each set of cells (and/or a predefined grouping of sets of cells) may be discharged through the multiplexing switch apparatus. In this example, no multiplexing may be used to discharge the cells, despite discharging through the multiplexing switch apparatus as cells are not selectively discharged. Alternatively or additionally, the controller may bypass the multiplexing switch apparatus entirely, such as using alternative discharging paths around the multiplexing switch apparatus.

In some embodiments, discharging without multiplexing may include discharging more cells or cell sets (e.g., at a given time) than are discharged when using the multiplexing switch to discharge (selectively discharging). In some embodiments, discharging without multiplexing can include discharging all cells or cell sets within the battery, whereas selectively discharging can include discharging a subset of the cells or cell sets.

In some embodiments, the controller may be configured to monitor power demand over an interval of time. For example, one or more power demand requests may be received over the period of time. In some embodiments, the power demand compared to the threshold may be and/or include an average power demand over the interval of time. As one example, the interval of time may be between 1 and 10 seconds, though intervals of time may vary during operation and/or according to the application.

In some embodiments, multiplexing may not be used for charging despite the power demand technically being below a threshold power demand (as the power demand is negative). For example, when a charging spike occurs (shown twice in FIG. 2 as spikes of the graph below the horizontal axis), the controller may not switch or apply multiplexing despite the power demand being below the threshold. The inventors have recognized that the decision to multiplex based on a threshold power demand may be most relevant for discharging, whereas for charging, low rates are more desirable, and so more or all cells or cell sets may be charged at a time.

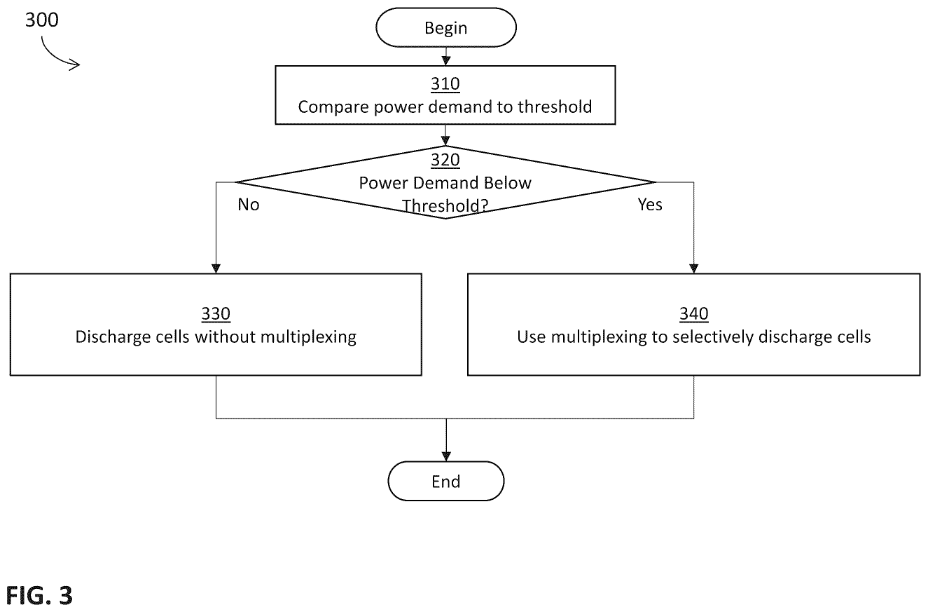

FIG. 3 is a flow chart depicting a representative process for managing electrochemical cells, according to some embodiments. The electrochemical cells can be, for example, the electrochemical cells 121A-121C, cell sets 121-124, and so on of exemplary FIG. 1. The acts of representative process 300 are described in detail in the paragraphs that follow.

In some embodiments, representative process 300 may include act 310, wherein a power demand may be compared to the threshold. In some embodiments, representative process 300 may then proceed to act 320, wherein it is determined whether the power demand is below the threshold.

In some embodiments, the representative process 300 may include act 330, wherein if the power demand is not below the threshold, the cells are controlled such that the cells are discharged without multiplexing.

In some embodiments, the representative process 300 may include act 340, wherein if the power demand is below the threshold, the cells are controlled such that the cells are selectively discharged using multiplexing.

In some embodiments, process 300 may then end or repeat as desired.

According to some embodiments, a controller (e.g., controller 114 of FIG. 1) may perform acts 310-340.

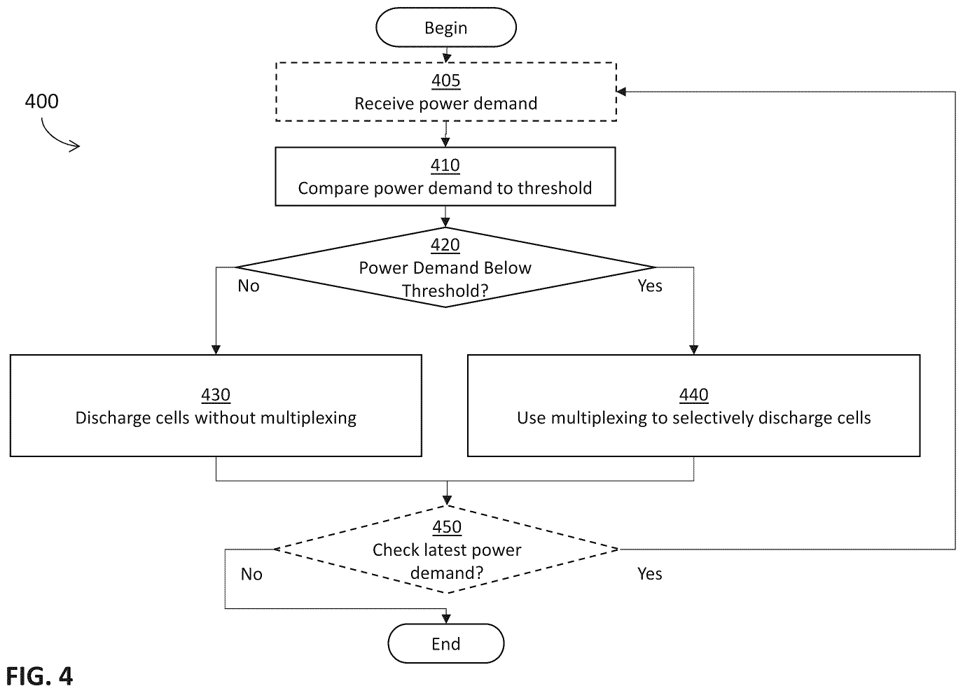

FIG. 4 is a flow chart depicting an additional representative process for managing electrochemical cells, according to some embodiments. The acts of representative process 400 are described in detail in the paragraphs that follow.

In some embodiments, the representative process 400 may also include optional act 405, which comprises receiving a power demand.

In some embodiments, representative process 400 may then proceed to act 410, wherein the power demand may be compared to the threshold. In some embodiments, representative process 400 may then proceed to act 420, wherein it is determined whether the power demand is below the threshold.

In some embodiments, the representative process 400 may include act 430, wherein if the power demand is not below the threshold, the cells are controlled such that the cells are discharged without multiplexing.

In some embodiments, the representative process 400 may include act 440, wherein if the power demand is below the threshold, the cells are controlled such that the cells are selectively discharged using multiplexing.

In some embodiments, process 400 may then proceed to act 450, wherein it is determined whether the latest power demand should be checked. If the latest power demand should be checked, process 400 may then return to act 405. If the latest power demand should not be checked, process 400 may then end or repeat as desired.

According to some embodiments, a controller (e.g., controller 114 of FIG. 1) may perform acts 405-450.

In some embodiments, the controller may use the multiplexing switch apparatus to selectively discharge and charge the cells or sets of cells at different, programmable rates. For example, the controller may use the multiplexing switch apparatus to selectively discharge the cells or sets of cells at a first rate at least 2 times higher than a second rate of charging the sets of cells (i.e., discharging twice as fast as charging). Alternatively or additionally, the first rate of discharging may be at least 4 times higher than the second rate of charging the sets of cells (i.e., discharging four times as fast as charging). The inventors have recognized and appreciated that such ratios of discharge rate to charge rate may improve the performance and cycle life of the cells.

According to some embodiments, the controller may temporally overlap the discharge of the sets of cells. For example, before a given cell or set of cells ceases discharging, another cell or set of cells may begin discharging. In some embodiments, the controller may continue to provide power from the sets of cells during switching between different sets. The inventors have recognized and appreciated that this temporal overlap of discharging and continuation of power may maintain the power requirements of the load even during transition between different cells of sets of cells, which may further improve the cycle life of the cell(s) compared to conventional techniques. Accordingly, multiple cells may discharge simultaneously during such an overlap. Additionally, such an overlap may provide smoother transition of voltage than has been possible with conventional techniques.

In some embodiments, the load may be at least one component of a vehicle. The vehicle may be any suitable vehicle, adapted for travel on land, sea, and/or air. For example, the vehicle may be an automobile, truck, motorcycle, boat, helicopter, airplane, and/or any other suitable type of vehicle.

Alternatively or additionally, the controller may use the multiplexing switch apparatus (e.g., 112) to connect the sets of cells to a load in a topology employed or required by the load.

In some embodiments, the controller may use the multiplexing switch apparatus (e.g., 112) to isolate a single set of cells for discharging while other sets of cells are not discharging. Alternatively or additionally, a single cell may be isolated at a time. For example, the controller may use the multiplexing switch apparatus to isolate a single set of cells or a single cell for discharging while the other cells or sets of cells are not discharging. For a given cycle, each cell may be discharged once before any cell is discharged twice, according to some embodiments (e.g., where sequential discharging is used, but not limited to such embodiments).

As for charging, in some embodiments the controller may use the multiplexing switch apparatus to charge the sets of cells, and/or cells within a set, in parallel. For example, all the cells in the cell block, battery, or batteries may be charged in parallel at a rate one-fourth of the rate of discharge.

In some embodiments, the controller may control the cell such that, for at least a portion of a charging step of the cell, the cell is charged at a charging rate or current that is lower than a discharging rate or current of at least a portion of a previous discharging step. For example, the controller may cause the cell to be charged for some state of charge range (e.g., over a range having breadth of anywhere from 1% to 100%) at a charging rate or current that is on average at least 2 times lower than the discharging rate or current that has been used on average discharging for some state of charge range (e.g., over a range having breadth of anywhere from 1% to 100%) (i.e., the charging rate or current may be half as fast as the discharging rate or current). Alternatively or additionally, the controller may cause the cell to be charged at a charging rate or current that is at least 4 times lower than the discharging rate (e.g., as a result of this controlling, over the last cycle, the cell is charged for some range one-fourth as fast as the cell has been discharged for some range). The inventors have recognized and appreciated that such ratios of charge rate to discharge rate may improve the performance and cycle life of a cell.

In some embodiments, controlling the cell may include controlling when and how to start and stop charging and discharging, induce discharging, increase or decrease the rate or current of charging or discharging, and so on. For example, controlling charging or discharging of the cell may include, respectively, starting charging or discharging, stopping charging or discharging, increasing or decreasing the rate or current of charging or discharging, and so on.

In some embodiments, the cell is charged such that, over a period of time during which at least 5% (or at least 1%, or at least 10%, or at least 15%, or at least 25%, or anywhere between) of the capacity of the cell is charged, the average charge rate or current is lower than the average discharge rate or current used to discharge at least 5% (or at least 10%, or at least 15%, or at least 25%, or anywhere between) of the cell's capacity during a previous discharging step, which may be, for example, the immediately preceding discharging step or an earlier discharging step.

In some embodiments, a charging step is performed such that, for at least 5% (or at least 10%, at least 25%, at least 50%, or at least 75%) of the cell's or battery's capacity, the average of the charging rate and/or current is less than 50% (or less than 35%, or less than 25%) of an average discharging rate and/or current at which at least 5% (or at least 10%, at least 25%, at least 50%, or at least 75%) of the cell's or battery's capacity was discharged during a previous discharging step.

In certain embodiments, a charging step is performed such that, for at least 5% (or at least 10%, at least 25%, at least 50%, or at least 75%) of the cell's or battery's capacity, the average of the charging rate and/or current is less than 50% (or less than 35%, or less than 25%) of an average discharging rate and/or current at which at least 5% (or at least 10%, at least 25%, at least 50%, or at least 75%) of the cell's or battery's capacity was discharged during the immediately preceding discharging step.

In some embodiments, an average discharging rate or current during the previous discharging step may be equal to or less than an average charging rate or current during the charging step, and an average discharging rate or current during discharge of a state of charge range have breadth of at least 5% during the previous discharging step may be at least 2 times higher (or may be 4 times higher) than the average charging rate or current during the charging step. The inventors have recognized and appreciated that improvements described herein, such as improved cell cycle life, can still be had even if the average discharge rate for the cell is the same or even slower than the charge rate, so long as during discharge of at least a portion (such as state of charge range having breadth of 5%) during the previous discharging step, an average discharging rate or current is sufficiently higher than (such as at least double, triple, or quadruple) the average charging rate or current during that time.

As used herein, when a cell is charged at multiple different rates over a given period of time (e.g., over a portion of a charging step, over an entire charging step, or over a series of charging steps), the average charging rate over that given period of time is calculated as follows:

$${CR}_{A v g} = {\sum }_{i = 1}^{n} \frac{{CCap}_{i}}{{CCap}_{T o t a l}} {CR}_{i}$$

where CR_{Avg} is the average charging rate over the given period of time, n is the number of different rates at which the cell is charged, CRi is the charging rate, CCapᵢ is the portion of the cell's capacity that is charged at charging rate CRᵢ during the given period of time, and CCap_{Total} is the total of the cell's capacity that is charged over the entire period of time. To illustrate, if, during a charging step, a cell is charged from 0% to 50% of its capacity at a rate of 20 mAh/minute and then from 50% to 80% of its capacity at a rate of 10 mAh/minute, then the average charging rate during the charging step would be calculated as:

$${CR}_{A v g} = \frac{50 \%}{80 \%} ( 20 m Ah / min ) + \frac{30 \%}{80 \%} ( 10 mAh / min ) = 16.25 mAh / min .$$

As used herein, when a cell is discharged at multiple different rates over a given period of time (e.g., over a given charging step or series of charging steps), the average discharging rate over that given period of time is calculated as follows:

$${DR}_{A v g} = {\sum }_{i = 1}^{n} \frac{{DCap}_{i}}{{DCap}_{Total}} {DR}_{i}$$

where DR_{Avg} is the average discharging rate over the given period of time, n is the number of different rates at which the cell is discharged, DRi is the discharging rate, DCapᵢ is the portion of the cell's capacity that is discharged at discharging rate DRi during the given period of time, and DCap_{Total} is the total of the cell's capacity that is discharged over the entire period of time. To illustrate, if, during a discharging step, a cell is discharged from 90% to 50% of its capacity at a rate of 25 mAh/minute and then from 50% to 20% of its capacity at a rate of 15 mAh/minute, then the average discharging rate during the discharging step would be calculated as:

$${DR}_{A v g} = \frac{40 \%}{70 \%} ( 25 mAh / min ) + \frac{30 \%}{70 \%} ( 15 mAh / min ) = 20.71 mAh / min .$$

The inventors have recognized and appreciated that the cycle life of batteries may be further improved by monitoring the cycles of the cells and various properties (such as the duration of a connection between a load and a cell or cells currently connected to the load, or a more complex function considering multiple parameters) and selecting which cells to discharge when based on this monitoring, especially compared to conventional techniques, which relied on much simpler selection processes like “round robin” or considering a number of prior cycles.

The inventors have recognized and appreciated that a number of factors may go into determining charge rates that may improve the performance and cycle life of a cell such as a lithium metal cell, which may include rate of discharge, cell impedance, and/or cell State of Health (SOH). In some embodiments, the controller may be aware of these factors because it may measure parameters or characteristics (such as via sensor 116) that can be used to determine each of them. The controller may directly or indirectly measure charge and discharge current, Coulombs added or removed, cell impedance (capacitive and resistive), and/or cell pressure, size, and/or thickness.

In some embodiments, the controller may monitor such characteristic(s) of the cell. For example, the characteristic(s) may include at least a portion of a discharge history of the cell. Alternatively or additionally, the characteristic(s) may include at least one morphological characteristic of the cell. The controller may monitor any of these using sensor 116, such as a pressure sensor, a gauge to measure thickness, a sensor to measure or determine surface roughness and/or pits (such as pits in an anode), and/or a memory for storing cell charge/discharge history. For example, a pressure sensor may be included to measure uniaxial pressure and/or gas pressure (such as to determine if the cell generates an excessive amount of gas). Alternatively or additionally, a gauge may be included to measure a thickness of the cell, and the controller may determine and monitor at least one rate of increase of the thickness.

In some embodiments, the controller may use this information, such as the characteristic(s), to determine the charge method and/or rate to be used, which may include controlling rates or other parameters as described herein.

In some embodiments, the controller may consider any of several factors when determining the cell state of charge and State of Health (SOH). An impedance measurement may have two components: real and imaginary. The real component may be simply the DC resistance R=RS+RP. The imaginary (or reactive) component in this case may be XC, which may be affected inversely by frequency:

$$XC = \frac{1}{2 π f c}$$

where f is frequency and c is capacitance. Impedance (Z) may be found at any particular frequency, and the phase angle may be known or determined as follows: Z=\sqrt{R²+XC²}. Impedance may change both with SOC and SOH. The inventors have recognized and appreciated that these relationships may allow the controller to determine how to charge the cell in order to provide improvements described herein.

The inventors have also recognized and appreciated that, in certain instances, pulses of cycles and/or charging/discharging steps should not be applied faster than a rate equal to about double or triple RC time constants, because at a faster rate, most of the energy may not be effective in charging or discharging the cell. Rather, it may be mostly reactive in nature and most of the energy may be returned by the capacitance or dissipated in the resistance.

The inventors have further recognized and appreciated that a cell grows and shrinks in thickness with every cycle and that a portion of the growth is retained each cycle. This growth and shrinkage can be measured by monitoring the pressure and/or size change of the cell directly. These are additional inputs that may be used when determining SOC and SOH, and they can also be used in determining how to charge the cell.

In some embodiments, the controller may control charging of the cell based on the characteristic(s) of the cell. For example, if the cell has had a discharging step or history of discharging at a certain discharge rate or current (such as 300 mA) at least for a portion of the previous discharging step, the cell may be controlled to charge at a lower rate or current (such as at 150 mA or 75 mA) for at least a portion of the charging step.

In some embodiments including an induced discharge, the controller may control the cell such that, for at least a portion of the charging step (such as 5% of the cycle), the cell is charged at a charging rate or current that is lower than a discharging rate or current of at least a portion of a previous discharging step other than (i.e., not including) the induced discharge.

As another example, the controller may terminate usage of the cell if an applied anisotropic pressure falls below a threshold, which may indicate that the pressure applying system (examples of which are described in more detail below) is damaged. For example, in some embodiments such a threshold may be 1% to 50% of nominal applied anisotropic pressure. Alternatively or additionally, the controller may terminate usage of the cell if pressure is too high or the thickness has been increasing faster than a threshold rate. For example, in some embodiments such a threshold rate may be 1% to 3% of thickness increase or more per cycle.

The inventors have recognized and appreciated that such improvements and others described herein, such as improved cell cycle life, can be had even if not every charging step and/or every discharging step satisfies a target ratio, and/or even if the ratios are employed over only a portion of a charging step and/or a discharging step, and/or even if the ratios are employed over a state of charge range that constitutes only a portion of the full SOC range.

For example, some embodiments are directed to a cell management system that controls a cell such that the cell is discharged or charged over a SOC range (e.g., a range having breadth of at least 2% and at most 60%) to satisfy a rate ratio (such as by discharging at a rate at least 2 times an average charging rate of any of the last 5 cycles, or by charging to establish a similar ratio with discharging rate(s)) if the ratio has not been satisfied within the last 5 cycles. As another example, in some embodiments the cell is discharged over a SOC range to satisfy another rate ratio (such as by discharging at a rate at least 2 times an average discharging rate of any of the last 5 cycles, but discharging at at most 4 times a maximum recommended continuous discharging rate) if the ratio has not been satisfied within the last 5 cycles.

As an additional example, in some embodiments, once a threshold SOC (e.g., 60% or less) is reached while discharging, the discharging rate is increased to at least 2 times an average charging rate of at least one cycle in the cycle history. In some embodiments, a charging step is terminated (e.g., at 60% SOC) and a discharge is initiated, whereupon the cell is discharged, over a SOC range having breadth of at least 1%, at a rate at least 2 times an average charging rate of the terminated charging step or of at least one cycle in the cycle history. In additional embodiments, the cell is discharged over a SOC range (e.g., a range having breadth of at least 2% and at most 60%), and then charged such that the discharging rate is at least 2 times the average charging rate.

In further embodiments, if a fast charging request has not been received, the cell is charged over a first SOC range (e.g., a range having breadth of at least 2% and at most 60%), and then charged over a second SOC range such that the rate over the first SOC range is at most 0.5 times the average rate over the second SOC range. In some embodiments, the cell is discharged, and then immediately charged over a first SOC range (e.g., a range having breadth of at least 2% and at most 60%), and a future charging schedule is set and executed such that by an end of the next 4 cycles, the cell is charged over a second SOC range such that the rate over the first SOC range is at most 0.5 times the average rate over the second SOC range.

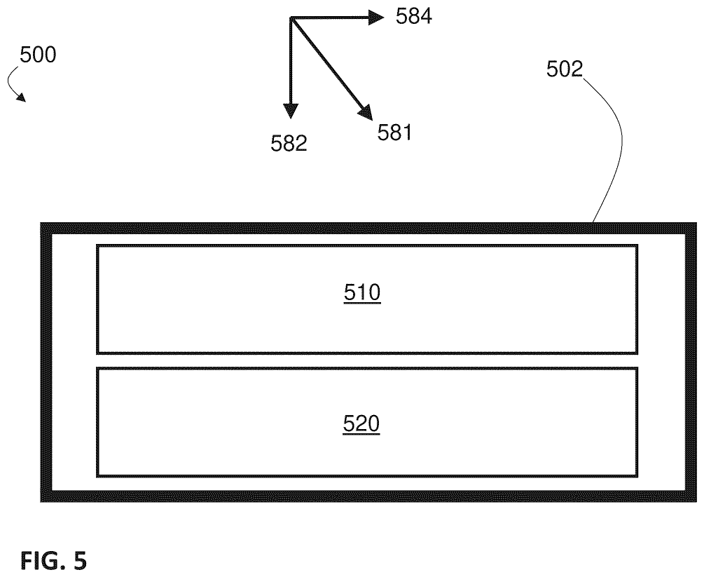

The systems and processes described above may be used to manage any of a variety of suitable batteries. Generally, a battery comprises a first electrochemical cell and a second electrochemical cell. In some embodiments, the battery comprises one or more rechargeable lithium-ion electrochemical cells. In some embodiments, one or more electrochemical cells of the battery are at least partially enclosed by a housing. For example, FIG. 5 is a cross-sectional schematic diagrams a non-limiting embodiment of a battery 500 comprising multiple electrochemical cells. Battery 500 in FIG. 5 comprises first electrochemical cell 510 and second electrochemical cell 520 at least partially enclosed by housing 502. The battery may additionally comprise one or more other components (e.g., lateral support components, articles stacked with the electrochemical cells, housings, electrical and thermal management equipment) described in greater detail below.

In some embodiments, the battery comprises a component that is configured to inhibit lateral movement (e.g., buckling) of cells within a stack of electrochemical cells of the battery. For example, the battery may comprise a lateral support component, as described in greater detail below. In some embodiments, the lateral support component is configured to inhibit motion of the first electrochemical cell and/or the second electrochemical cell, as described in greater detail below. In some embodiments, at least one electrochemical cell of the battery (e.g., first electrochemical cell, second electrochemical cell) comprises lithium metal and/or a lithium metal alloy as an electrode active material.

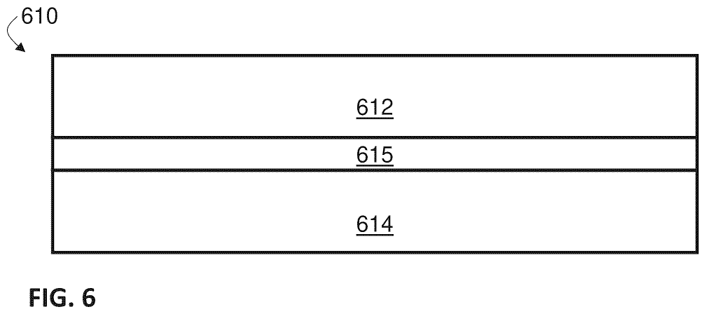

In some embodiments, electrochemical cells in the battery (e.g., the first electrochemical cell, the second electrochemical cell) comprise at least one anode. FIG. 6 shows a schematic diagram of one embodiment of first electrochemical cell 610 comprising anode 612. In some cases, the anode comprises an anode active material. As used herein, an “anode active material” refers to any electrochemically active species associated with an anode. In some embodiments, the anode comprises lithium metal and/or a lithium metal alloy as an anode active material. For example, referring again to FIG. 6, anode 612 comprises lithium metal and/or a lithium metal alloy as an anode active material in some embodiments. An electrode such as an anode can comprise, in accordance with certain embodiments, lithium metal and/or a lithium metal alloy as an electrode active material during at least a portion of or during all of a charging and/or discharging process of the electrochemical cell. In certain cases, the anode is or comprises vapor-deposited lithium (e.g., a vapor-deposited lithium film). Additional suitable anode active materials are described in more detail below. Certain embodiments described herein may be directed to systems, devices, and methods that may allow for improved performance (e.g., magnitude and/or uniformity of applied force, alignment of electrochemical active regions to promote uniformity of lithium deposition during charging) of electrochemical cells comprising certain anodes, such as lithium metal-containing anodes.

In some embodiments, electrochemical cells in the battery (e.g., the first electrochemical cell, the second electrochemical cell) comprise at least one cathode. For example, referring again to FIG. 6, first electrochemical cell 610 comprises cathode 614. The cathode can comprise a cathode active material. As used herein, a “cathode active material” refers to any electrochemically active species associated with a cathode. In certain cases, the cathode active material may be or comprise a lithium intercalation compound (e.g., a metal oxide lithium intercalation compound). As one non-limiting example, in some embodiments, cathode 614 in FIG. 6 comprises a nickel-cobalt-manganese lithium intercalation compound. Additional examples of suitable cathode active materials are described in more detail below.

As used herein, “cathode” refers to the electrode in which an electrode active material is oxidized during charging and reduced during discharging, and “anode” refers to the electrode in which an electrode active material is reduced during charging and oxidized during discharging.

In some embodiments, electrochemical cells in the battery (e.g., the first electrochemical cell, the second electrochemical cell) comprise a separator between the anode and the cathode. FIG. 6 shows, as a non-limiting example, separator 615 between anode 612 and cathode 614. The separator may be a solid electronically non-conductive or insulative material that separates or insulates the anode and the cathode from each other, preventing short circuiting, and that permits the transport of ions between the anode and the cathode. In some embodiments, the separator is porous and may be permeable to an electrolyte.

It should be understood that while in some embodiments the first electrochemical cell and the second electrochemical cell have the same types of components (e.g., same anode active material, same cathode active material, same type of separator), in other embodiments the first electrochemical cell has one or more different components than the second electrochemical cell (e.g., a different anode active material, a different cathode active material, a different type of separator). In some embodiments, the first electrochemical cell and the second electrochemical cell are identical in composition and/or dimensions.

In some embodiments, the battery comprises a stack comprising electrochemical cells (e.g., the first electrochemical cell, the second electrochemical cell). It should be understood that the stack may be a multicomponent stack comprising non-cell components such as thermally insulating compressible solid article portions, thermally conductive solid article portions, lateral support components, and/or sensors, as discussed in greater detail below.

The stack of electrochemical cells may have an aspect ratio defined by a ratio between a length of a smallest lateral dimension of the stack of electrochemical cells and a length of the stack of electrochemical cells. In some embodiments, the stack of electrochemical cells has an aspect ratio of greater than or equal to 1, greater than or equal to 1.5, greater than or equal to 2, greater than or equal to 3, greater than or equal to 5, or greater. In some embodiments, the stack of electrochemical cells has an aspect ratio of less than or equal to 20, less than or equal to 10, less than or equal to 8, or less than or equal to 6. Combinations of these ranges are possible. For example, in some embodiments, stack of electrochemical cells has an aspect ratio of greater than or equal to 1 and less than or equal to 20.

The battery may have an aspect ratio defined by a ratio between a length of a smallest lateral dimension of the battery and a length of the battery. In some embodiments, the battery has an aspect ratio of greater than or equal to 1, greater than or equal to 1.5, greater than or equal to 2, or greater. In some embodiments, the battery has an aspect ratio of less than or equal to 20, less than or equal to 10, less than or equal to 5, less than or equal to 3, less than or equal to 2, or less. Combinations of these ranges are possible. For example, in some embodiments, battery has an aspect ratio of greater than or equal to 1 and less than or equal to 20. In some embodiments, the aspect ratio of the stack of electrochemical cells is relatively close to the aspect ratio of the battery; however, these aspect ratios may also be different, and the disclosure is not so limited.

It should be understood that the battery may not be limited to two electrochemical cells, and may comprise at least 2, at least 3, at least 4 at least 5, at least 8, at least 10, and/or up to 12, up to 15, up to 20, up to 24, up to 30, up to 40, up to 48, or more electrochemical cells.

In some embodiments, the battery comprises a housing. The housing may at least partially enclose other components of the battery. For example, the housing may at least partially enclose the first electrochemical cell and the second electrochemical cell. FIG. 5 shows housing 502 at least partially enclosing first electrochemical cell 510 and second electrochemical cell 520, according to certain embodiments. The housing may comprise rigid components. As one example, the housing may comprise one or more solid plates. The solid plate may, for example, be an endplate. In certain cases, the housing does not comprise a solid plate. For example, in some cases, the solid surface and other components of a containment structure of a housing configured to house the electrochemical cells are part of a unitary structure.

As mentioned above, in some embodiments, the battery comprises a housing. The housing may at least partially enclose the electrochemical cells of the stack. In some embodiments, the battery comprises one or more solid plates that are part of the housing. In some such cases, the housing is configured to apply the anisotropic force via a solid plate. The solid plates may be, for example, endplates configured to apply an anisotropic force to the electrochemical cells of the stack.

In some embodiments, the housing of the battery further comprises a solid housing component coupled to a solid plate. In some embodiments, the solid housing component is a discrete object separate from the solid plate rather than part of a unitary object with the solid plate (though in some embodiments the solid housing component and the solid plate are part of a unitary solid object). The solid housing component (e.g., discrete solid housing component) may contribute, at least in part, to application of anisotropic force by the housing (e.g., to an electrochemical cell in the stack). For example, in some embodiments, the housing is configured to apply, via the solid plate and tension in the solid housing component coupled to the solid plate, during at least one period of time during charge and/or discharge of the first electrochemical cell and/or the second electrochemical cell, an anisotropic force with a component perpendicular to a first electrode surface of the first electrochemical cell and/or a second electrode surface of the second electrochemical cell, as described above.

The solid housing component may couple (or contribute to coupling of) the solid plate covering at least a portion of a first end of the stack to a component of the housing covering at least a portion of second end of the stack. Such a coupling via the solid housing component may contribute to the anisotropic force applied by the housing. In some embodiments, the solid housing component spans from the solid plate to the second end of the stack. It should be understood that an object spanning from a first element to a second element may extend past some or all of either the first element of the second element, provided that it reaches at least a portion of each the two elements in the direction of the spanning. In some embodiments in which the housing comprises a first solid plate covering at least a portion of the first end of the stack and a second solid plate covering at least a portion of the second end of the stack, the solid housing component spans from the first solid plate to the second solid plate.

According to certain aspects, the battery comprises a lateral support component. The lateral support component may be configured to reinforce the stack against movement of at least one cell of the stack in a lateral dimension (e.g., at least one direction having a component perpendicular to a component of anisotropic force that is perpendicular to an electrode surface. For example, the lateral support component may be configured to support the stack of electrochemical cells against a housing at least partially enclosing the stack of electrochemical cells. The lateral support component may be configured to inhibit (e.g., prevent) motion of an electrochemical cell (e.g., a first electrochemical cell a second electrochemical cell) in a direction that is substantially perpendicular or otherwise not substantially parallel to a component of applied anisotropic force perpendicular to an electrode surface (e.g., lateral motion). Two directions (e.g., a direction of motion and a direction of an anisotropic force component) can be substantially perpendicular if, for example, an angle between the two directions is within ±20°, ±10°, ±5°, or ±2° of a 90° angle (i.e., if the angle between the two directions is between 70° and 110°, between 80° and 100°, between 85° and 95°, or between 88° and 92°).

Some embodiments are related to applying, during at least one period of time during charge and/or discharge of the electrochemical cells (e.g., first electrochemical cell, second electrochemical cell), an anisotropic force with a component perpendicular to an electrode surface of at least one electrochemical cell of the battery. Application of such a force may reduce potentially deleterious phenomena associated with certain types of electrochemical cells (e.g., cells comprising lithium metal as an electrode active material) and improve utilization. For example, in some cases, applying an anisotropic force with a component perpendicular to an electrode surface of an electrode of the electrochemical device can reduce problems (such as surface roughening of the electrode and dendrite formation) while improving current density. Electrochemical devices in which anisotropic forces are applied and methods for applying such forces are described, for example, in U.S. Pat. No. 9,105,938, issued Aug. 11, 2015, published as U.S. Patent Publication No. 2010/0035128 on Feb. 11, 2010, and entitled “Application of Force in Electrochemical Cells,” which is incorporated herein by reference in its entirety for all purposes.

FIG. 5 depicts a schematic cross-sectional illustration of a force that may be applied to the first electrochemical cell and the second electrochemical cell in the direction of arrow 581. Arrow 582 illustrates the component of force 581 that is perpendicular to top electrode surface of first electrochemical cell 510, according to certain embodiments. In some embodiments, the electrode surface to which the component is perpendicular is a major surface of the electrode (i.e., a surface having, at its edges, the two largest dimensions of the electrode). The electrode surface to which the component is perpendicular may, in accordance with certain embodiments, be an electrode active surface. As used herein, the term “electrode active surface” is used to describe a surface of an electrode at which electrochemical reactions may take place. As one example, in embodiments in which the electrode comprises a lithium metal foil as the anode active material, the external surface of the lithium metal foil would be an active surface of the electrode. In general, the electrode active surface can be in physical contact with an electrolyte when the electrode is part of an electrochemical cell, such that the electrolyte transports ions or other non-electron electrochemically active reactants between that electrode and a counter-electrode.

In some embodiments, the battery (e.g., a housing of the battery) is configured to apply, during at least one period of time during charge and/or discharge of the first electrochemical cell and/or the second electrochemical cell, an anisotropic force having a relatively high-magnitude component perpendicular to (i.e., normal to) electrode surfaces of at least one (or all) of the electrochemical cells in the battery. For example, in some embodiments where the battery comprises a first electrochemical cell having a first electrode surface and a second electrochemical cell having a second electrode surface, the housing of the battery is configured to apply, during at least one period of time during charge and/or discharge of the first electrochemical cell and/or the second electrochemical cell, an anisotropic force having a relatively high-magnitude component perpendicular to the first electrode surface and the second electrode surface. The housing may be configured to apply such a force in a variety of ways. For example, in some embodiments, the housing comprises two solid articles (e.g., a first solid plate and a second solid plate). An object (e.g., a machine screw, a nut, a spring, etc.) may be used to apply the force by applying pressure to the ends (or regions near the ends) of the housing. In the case of a machine screw, for example, the electrochemical cells and other components of the battery may be compressed between the plates (e.g., a first solid plate and a second solid plate) upon rotating the screw. As another example, in some embodiments, one or more wedges may be displaced between the housing and a fixed surface (e.g., a tabletop, etc.). The force may be applied by driving the wedge between the housing (e.g., between a solid plate of a containment structure of the housing) and the adjacent fixed surface through the application of force on the wedge (e.g., by turning a machine screw).

Some embodiments comprise applying an anisotropic force with a component perpendicular to a first electrode surface (e.g., an electrode active surface) of the first electrochemical cell and/or a second electrode surface (e.g., an electrode active surface) of the second electrochemical cell, where the component defines a pressure of at least at least 3 kg_{f}/cm², at least 5 kg_{f}/cm², 10 kg_{f}/cm², at least 12 kg_{f}/cm², at least 20 kg_{f}/cm², and/or up 25 kg_{f}/cm², or more. In some such cases, the housing is configured to apply such anisotropic forces. While high magnitudes of anisotropic force with a component perpendicular to an electrode surface can improve performance, too high of a magnitude of force may cause problems such as damage to certain components of the battery (e.g., the thermally insulating compressible solid article portion described below). It has been observed, however, that there are ranges of magnitudes of anisotropic force that can be applied that can, in some cases, achieve desirable performance of the battery while avoiding such damage. For example, some embodiments comprise applying (e.g., via the housing) during at least one period of time during charge and/or discharge of the first electrochemical cell and/or the second electrochemical cell, an anisotropic force with a component perpendicular to a first electrode surface of the first electrochemical cell and/or a second electrode surface of the second electrochemical cell defining a pressure of less than or equal to 40 kg_{f}/cm² less than or equal to 35 kg_{f}/cm² less than or equal to 30 kg_{f}/cm², less than or equal to 25 kg_{f}/cm² or less. Combinations of these ranges (e.g., at least 10 kg_{f}/cm² and less than or equal to 40 kg_{f}/cm², at least 10 kg_{f}/cm² and less than or equal to 25 kg_{f}/cm², or at least 12 kg_{f}/cm² and less than or equal to 30 kg_{f}/cm²) are possible.

In some embodiments where the first electrochemical cell and the second electrochemical cell are part of a stack of cells, an anisotropic force with a component perpendicular to a lateral surface of the stack (corresponding to an end of the stack rather than a side of the stack) defining a pressure in one of the aforementioned ranges is applied. In some embodiments where the first electrochemical cell and the second electrochemical cell are part of a stack of cells, an anisotropic force with a component substantially parallel to the direction in which the cells are stacked defining a pressure in one of the aforementioned ranges is applied. In this context (and in all other contexts herein in which the term is used), “substantially parallel” can be within 20°, within 10°, within 5°, or within 2° of parallel, in some embodiments.

In some embodiments, the magnitude of anisotropic force defines a pressure of 10-15 kg_{f}/cm² at a 0% SOC and 25-35 kg_{f}/cm² at a 100% SOC. In one example of an embodiment, the magnitude of anisotropic force defines a pressure of 12 kg_{f}/cm² at a 0% SOC and 30 kg_{f}/cm² at a 100% SOC.

Some embodiments comprise applying an external anisotropic force to a stack at least partially enclosed by a housing described above (e.g., with one or more solid housing components), the stack comprising a first electrochemical cell and a second electrochemical cell. As mentioned above, the external anisotropic force may have a component perpendicular to a first electrode surface of the first electrochemical cell and/or a second electrode surface of the second electrochemical cell. The external anisotropic force may be applied via a pressure application device/system external to the battery (e.g., an external clamp, a hydraulic press, etc.), and may be applied, for example, during manufacture of a battery comprising the stack and the housing. The external anisotropic force may define a pressure of at least 3 kg_{f}/cm², at least 5 kg_{f}/cm², at least 10 kg_{f}/cm², at least 12 kg_{f}/cm², at least 20 kg_{f}/cm², and/or up to 25 kg_{f}/cm², up to 30 kg_{f}/cm², up to 35 kg_{f}/cm², up to 40 kg_{f}/cm², or more.

In some embodiments where the first electrochemical cell and the second electrochemical cell are part of a stack of cells, an anisotropic force with a component perpendicular to a lateral surface of the stack (corresponding to an end of the stack rather than a side of the stack) defining a pressure in one of the aforementioned ranges is applied. In some embodiments where the first electrochemical cell and the second electrochemical cell are part of a stack of cells, an anisotropic force with a component substantially parallel to the direction in which the cells are stacked defining a pressure in one of the aforementioned ranges is applied.

In the embodiments described herein, batteries may undergo a charge/discharge cycle involving deposition of metal (e.g., lithium metal or other active material) on a surface of an anode upon charging and reaction of the metal on the anode surface, wherein the metal diffuses from the anode surface, upon discharging. The uniformity with which the metal is deposited on the anode may affect cell performance. For example, when lithium metal is removed from and/or redeposited on an anode, it may, in some cases, result in an uneven surface. For example, upon redeposition it may deposit unevenly forming a rough surface. The roughened surface may increase the amount of lithium metal available for undesired chemical reactions which may result in decreased cycling lifetime and/or poor cell performance. The application of force to the electrochemical device has been found, in accordance with certain embodiments described herein, to reduce such behavior and to improve the cycling lifetime and/or performance of the cell.

An anisotropic force with a component perpendicular to an electrode surface of one of the electrochemical cells (e.g., first electrochemical cell, second electrochemical cell) may be applied during at least one period of time during charge and/or discharge of the battery. In some embodiments, the force may be applied continuously, over one period of time, or over multiple periods of time that may vary in duration and/or frequency. The anisotropic force may be applied, in some cases, at one or more pre-determined locations, optionally distributed over an electrode surface of the one or more of the electrochemical cells of the battery. In some embodiments, the anisotropic force is applied uniformly over one or more electrode surfaces of the anode.

An “anisotropic force” is given its ordinary meaning in the art and means a force that is not equal in all directions. A force equal in all directions is, for example, internal pressure of a fluid or material within the fluid or material, such as internal gas pressure of an object. Examples of forces not equal in all directions include forces directed in a particular direction, such as the force on a table applied by an object on the table via gravity. Another example of an anisotropic force includes certain forces applied by a band arranged around a perimeter of an object. For example, a rubber band or turnbuckle can apply forces around a perimeter of an object around which it is wrapped. However, the band may not apply any direct force on any part of the exterior surface of the object not in contact with the band. In addition, when the band is expanded along a first axis to a greater extent than a second axis, the band can apply a larger force in the direction parallel to the first axis than the force applied parallel to the second axis.

A force with a “component perpendicular” to a surface, for example an electrode surface of an electrode such as an anode, is given its ordinary meaning as would be understood by those of ordinary skill in the art and includes, for example, a force which, at least in part, exerts itself in a direction substantially perpendicular to the surface. As used herein, the word “normal” is used interchangeably with the word “perpendicular”.

In some embodiments, the anisotropic force can be applied such that the magnitude of the force is substantially equal in all directions within a plane defining a cross-section of the battery, but the magnitude of the forces in out-of-plane directions is substantially unequal to the magnitudes of the in-plane forces.

In one set of embodiments, a battery (e.g., using a housing of the battery) described herein is configured to apply, during at least one period of time during charge and/or discharge of the cell, an anisotropic force with a component perpendicular to an electrode surface of one of the electrochemical cells (e.g., first electrochemical cell, second electrochemical cell). In such an arrangement, the electrochemical cell may be formed as part of a container which applies such a force by virtue of a “load” applied during or after assembly of the cell, or applied during use of the battery as a result of expansion and/or contraction of one or more components of the battery itself.

In some cases, one or more forces applied to the cell have a component that is not perpendicular to an electrode surface of an anode. For example, in FIG. 5 force component 584 is not perpendicular to electrode surfaces of the first electrochemical cell 510 and second electrochemical cell 520. In one set of embodiments, the sum of the components of all applied anisotropic forces in a direction perpendicular to any electrode surface of the battery is larger than any sum of components in a direction that is not perpendicular to the electrode surface. In some embodiments, the sum of the components of all applied anisotropic forces in a direction perpendicular to any electrode surface of the battery is at least 5%, at least 10%, at least 20%, at least 35%, at least 50%, at least 75%, at least 90%, at least 95%, at least 99%, or at least 99.9% larger than any sum of components in a direction that is parallel to the electrode surface.

The battery may comprise components having a potentially advantageous arrangement (e.g., for thermal management). For example, in some embodiments, a stack is described comprising electrochemical cells and lateral support components, thermally conductive solid article portions, and/or thermally insulating compressible solid article portions.

Thermally conductive portions of lateral support components may promote heat transfer away from components of the battery (e.g., away from the electrochemical cells), in some instances while also facilitating alignment of electrochemical active regions of the electrochemical cells. In some cases, the thermally conductive portion of the lateral support component is in direct contact with the electrochemical cells. However, direct contact is not required, and in some embodiments, there are one or more intervening components (e.g., sensors, etc.) between thermally conductive portion of the lateral support component and the electrochemical cell.

In some embodiments, the battery comprises a thermally conductive solid article portion (e.g., as an alternative to or in addition to thermally conductive lateral support components). Thermally conductive solid article components may be used in addition to or as an alternative to thermally conductive lateral support components because thermally conductive solid articles may have a lower weight than thermally conductive lateral support components, while still improving a temperature distribution within the battery.

The electrochemical cell (e.g., the first electrochemical cell and/or second electrochemical cell) may be configured such that the housing does not restrict motion of the lateral support component in a direction substantially parallel to the component of the anisotropic force. For example, the electrochemical cell may be positioned such that it is disconnected from the housing and/or is capable of motion within the housing or along a track of the housing, like the lateral support component. This may allow the electrochemical cell to transmit anisotropic force through the stack of electrochemical cells. This may, advantageously, improve the spatial uniformity of force within the battery. Alternatively, in some embodiments, the lateral support component is configured to be flush with the housing, such that a track is not required.

In some aspects, batteries comprising solid articles that can compensate for dimensional changes of other battery components while also limiting heat transfer between electrochemical cells are generally described. For example, a battery described herein may include a thermally insulating compressible solid article portion. In some embodiments, the thermally insulating compressible solid article portion is situated between the first electrochemical cell and the second electrochemical cell.

The compressibility of the thermally insulating compressible solid article portion may be useful in any of a variety of applications. As one example, in some instances in which one or more components of the battery change dimension during a charging and/or discharge process, a resulting compression of the thermally insulating compressible solid article portion may compensate for that change in dimension. In some such cases, the compressibility of the thermally insulating compressible solid article portion under stress may reduce the extent to which a battery expands or contracts when electrochemical cells within the battery undergo expansion and/or contraction during cycling.

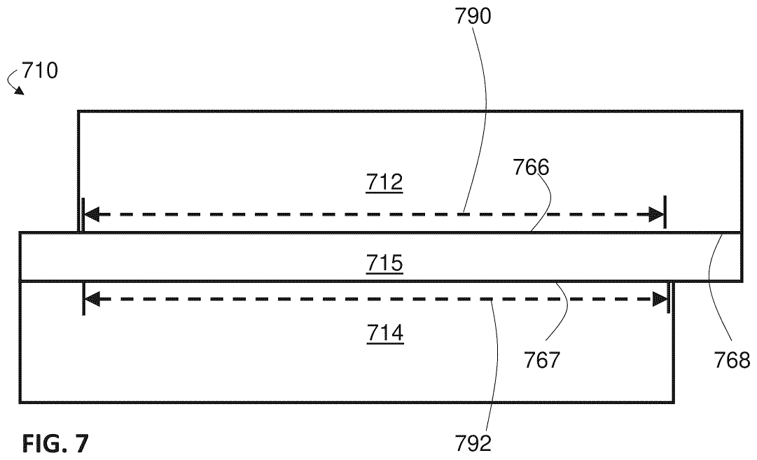

Each of the electrochemical cells in the batteries described herein may have an electrochemical active region. For example, FIG. 7 shows an embodiment first electrochemical cell 710 comprises first electrochemical active region 790 and second electrochemical cell 720 comprises second electrochemical active region 792. An electrochemical active region refers to a region defined by the overlap of the electrode surfaces that contain active material of the anodes and electrode surfaces that contain active material of the cathodes of the electrochemical cell. For example, in FIG. 7, first electrochemical cell 710 has electrochemical active region 790 defined by the overlap of anode electrode surface 766 of the anode (which contains anode active material) and electrode surface 767 of the cathode (which contains cathode active material). Anode 712 and cathode 714 are separated in FIG. 7 by separator 715. In some embodiments, a portion of an anode and/or cathode may not be part of the electrochemical active region of the electrochemical cell. For example, an anode and cathode may be offset such that a portion of an anode comprising the anode active material does not overlap with the corresponding cathode portion that contains cathode active material, thereby preventing that portion of the anode from participating in electrochemical reactions with the cathode. Referring to FIG. 7, portion 768 of anode 712 does not overlap with any of cathode 714 and therefore cannot participate in any electrochemical reactions with cathode 714, and therefore portion 718 of anode 712 is not part of first electrochemical active region 790, according to certain embodiments.

A variety of anode active materials are suitable for use with the anodes of the electrochemical cells described herein, according to certain embodiments. In some embodiments, the anode active material comprises lithium (e.g., lithium metal), such as lithium foil, lithium deposited onto a conductive substrate or onto a non-conductive substrate (e.g., a release layer), and lithium alloys (e.g., lithium-aluminum alloys and lithium-tin alloys). Lithium can be contained as one film or as several films, optionally separated. Suitable lithium alloys for use in the aspects described herein can include alloys of lithium and aluminum, magnesium, silicium (silicon), indium, and/or tin. In some embodiments, the anode active material comprises lithium (e.g., lithium metal and/or a lithium metal alloy) during at least a portion of or during all of a charging and/or discharging process of the electrochemical cell. In some embodiments, the anode active material comprises lithium (e.g., lithium metal and/or a lithium metal alloy) during a portion of a charging and/or discharging process of the electrochemical cell, but is free of lithium metal and/or a lithium metal alloy at a completion of a discharging process.

In some embodiments, the anode active material contains at least 50 wt % lithium. In some cases, the anode active material contains at least 75 wt %, at least 90 wt %, at least 95 wt %, or at least 99 wt % lithium.

In some embodiments, the anode is an electrode from which lithium ions are liberated during discharge and into which the lithium ions are integrated (e.g., intercalated) during charge. In some embodiments, the anode active material is a lithium intercalation compound (e.g., a compound that is capable of reversibly inserting lithium ions at lattice sites and/or interstitial sites). In some embodiments, the anode active material comprises carbon. In certain cases, the anode active material is or comprises a graphitic material (e.g., graphite). A graphitic material generally refers to a material that comprises a plurality of layers of graphene (i.e., layers comprising carbon atoms covalently bonded in a hexagonal lattice). Adjacent graphene layers are typically attracted to each other via van der Waals forces, although covalent bonds may be present between one or more sheets in some cases. In some cases, the carbon-comprising anode active material is or comprises coke (e.g., petroleum coke). In certain embodiments, the anode active material comprises silicon, lithium, and/or any alloys of combinations thereof. In certain embodiments, the anode active material comprises lithium titanate (Li₄Ti₅O₁₂, also referred to as “LTO”), tin-cobalt oxide, or any combinations thereof.

A variety of cathode active materials are suitable for use with cathodes of the electrochemical cells described herein, according to certain embodiments. In some embodiments, the cathode active material comprises a lithium intercalation compound (e.g., a compound that is capable of reversibly inserting lithium ions at lattice sites and/or interstitial sites). In certain cases, the cathode active material comprises a layered oxide. A layered oxide generally refers to an oxide having a lamellar structure (e.g., a plurality of sheets, or layers, stacked upon each other). Non-limiting examples of suitable layered oxides include lithium cobalt oxide (LiCoO₂), lithium nickel oxide (LiNiO₂), and lithium manganese oxide (LiMnO₂). In some embodiments, the layered oxide is lithium nickel manganese cobalt oxide (LiNiₓMn_{y}Co₂O₂, also referred to as “NMC” or “NCM”). In some such embodiments, the sum of x, y, and z is 1. For example, a non-limiting example of a suitable NMC compound is LiNi_{1/3}Mn_{1/3}Co_{1/3}O₂. In some embodiments, a layered oxide may have the formula (Li₂MnO₃)ₓ(LiMO₂)₍₁₋ₓ₎ where M is one or more of Ni, Mn, and Co. For example, the layered oxide may be (Li₂MnO₃)_{0.25}(LiNi_{0.3}Co_{0.15}Mn_{0.55}O₂)_{0.75}. Further details of potentially suitable cathode materials are described, for example, in U.S. Patent Publication No. 2021/0151839 A1, published on May 20, 2021, and entitled, “BATTERIES, AND ASSOCIATED SYSTEMS AND METHODS,” which is incorporated herein by reference in its entirety for all purposes.

In some embodiments, the cathode active material may be modified by a surface coating comprising an oxide. Non-limiting examples of surface oxide coating materials include: MgO, Al₂O₃, SiO₂, TiO₂, ZnO₂, SnO₂, and ZrO₂. In some embodiments, such coatings may prevent direct contact between the cathode active material and one or more components of the electrolyte, thereby suppressing side reactions.

Any of a variety of materials can be used as an electrolyte, in embodiments in which an electrolyte is present. The electrolyte can comprise, for example, a solution of ions, a solid electrolyte, a gel electrolyte, and/or a combination of these.

In some embodiments, the electrochemical cells of the battery further comprise a separator between two electrode portions (e.g., an anode portion and a cathode portion). The separator may be a solid non-conductive or insulative material, which separates or insulates the anode and the cathode from each other preventing short circuiting, and which permits the transport of ions between the anode and the cathode. In some embodiments, the porous separator may be permeable to the electrolyte. Solid electrolytes and gel electrolytes may also function as a separator in addition to their electrolyte function.

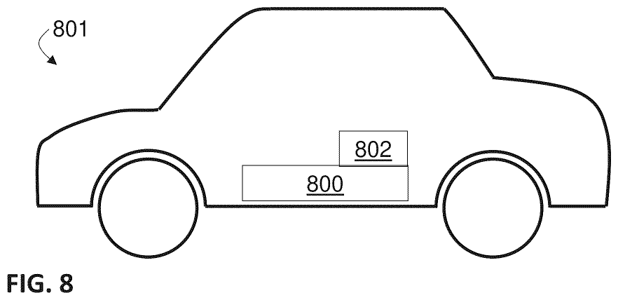

In some embodiments, the electrochemical cells and batteries (e.g., rechargeable batteries) described in this disclosure can be used to provide power to an electric vehicle or otherwise be incorporated into an electric vehicle. As a non-limiting example, stacks of electrochemical cells and/or batteries described in this disclosure (e.g., comprising lithium metal and/or lithium alloy electrochemical cells) can, in certain embodiments, be used to provide power to a drive train of an electric vehicle. The vehicle may be any suitable vehicle, adapted for travel on land, sea, and/or air. For example, the vehicle may be an automobile, truck, motorcycle, boat, helicopter, airplane, and/or any other suitable type of vehicle. FIG. 8 shows a cross-sectional schematic diagram of electric vehicle 801 in the form of an automobile comprising battery 800 and electrochemical cell management system 802, in accordance with some embodiments. Battery 800 can, in some instances, provide power to a drive train of electric vehicle 801.

It should be understood that when a portion (e.g., layer, structure, region) is “on”, “adjacent”, “above”, “over”, “overlying”, or “supported by” another portion, it can be directly on the portion, or an intervening portion (e.g., layer, structure, region) also may be present. Similarly, when a portion is “below” or “underneath” another portion, it can be directly below the portion, or an intervening portion (e.g., layer, structure, region) also may be present. A portion that is “directly on”, “directly adjacent”, “immediately adjacent”, “in direct contact with”, or “directly supported by” another portion means that no intervening portion is present. It should also be understood that when a portion is referred to as being “on”, “above”, “adjacent”, “over”, “overlying”, “in contact with”, “below”, or “supported by” another portion, it may cover the entire portion or a part of the portion.

The following applications are incorporated herein by reference, in their entirety, for all purposes: U.S. Publication No. US-2007-0221265-A1 published on Sep. 27, 2007, filed as U.S. application Ser. No. 11/400,781 on Apr. 6, 2006, and entitled “RECHARGEABLE LITHIUM/WATER, LITHIUM/AIR BATTERIES”; U.S. Publication No. US-2009-0035646-A1, published on Feb. 5, 2009, filed as U.S. application Ser. No. 11/888,339 on Jul. 31, 2007, and entitled “SWELLING INHIBITION IN BATTERIES”; U.S. Publication No. US-2010-0129699-A1 published on May 17, 2010, filed as U.S. application Ser. No. 12/312,764 on Feb. 2, 2010; patented as U.S. Pat. No. 8,617,748 on Dec. 31, 2013, and entitled “SEPARATION OF ELECTROLYTES”; U.S. Publication No. US-2010-0291442-A1 published on Nov. 18, 2010, filed as U.S. application Ser. No. 12/682,011 on Jul. 30, 2010, patented as U.S. Pat. No. 8,871,387 on Oct. 28, 2014, and entitled “PRIMER FOR BATTERY ELECTRODE”; U.S. Publication No. US-2009-0200986-A1 published on Aug. 13, 2009, filed as U.S. application Ser. No. 12/069,335 on Feb. 8, 2008, patented as U.S. Pat. No. 8,264,205 on Sep. 11, 2012, and entitled “CIRCUIT FOR CHARGE AND/OR DISCHARGE PROTECTION IN AN ENERGY-STORAGE DEVICE”; U.S. Publication No. US-2007-0224502-A1 published on Sep. 27, 2007, filed as U.S. application Ser. No. 11/400,025 on Apr. 6, 2006, patented as U.S. Pat. No. 7,771,870 on Aug. 10, 2010, and entitled “ELECTRODE PROTECTION IN BOTH AQUEOUS AND NON-AQUEOUS ELECTROCHEMICAL CELLS, INCLUDING RECHARGEABLE LITHIUM BATTERIES”; U.S. Publication No. US-2008-0318128-A1 published on Dec. 25, 2008, filed as U.S. application Ser. No. 11/821,576 on Jun. 22, 2007, and entitled “LITHIUM ALLOY/SULFUR BATTERIES”; U.S. Publication No. US-2002-0055040-A1 published on May 9, 2002, filed as U.S. application Ser. No. 09/795,915 on Feb. 27, 2001, patented as U.S. Pat. No. 7,939,198 on May 10, 2011, and entitled “NOVEL COMPOSITE CATHODES, ELECTROCHEMICAL CELLS COMPRISING NOVEL COMPOSITE CATHODES, AND PROCESSES FOR FABRICATING SAME”; U.S. Publication No. US-2006-0238203-A1 published on Oct. 26, 2006, filed as U.S. application Ser. No. 11/111,262 on Apr. 20, 2005, patented as U.S. Pat. No. 7,688,075 on Mar. 30, 2010, and entitled “LITHIUM SULFUR RECHARGEABLE BATTERY FUEL GAUGE SYSTEMS AND METHODS”; U.S. Publication No. US-2008-0187663-A1 published on Aug. 7, 2008, filed as U.S. application Ser. No. 11/728,197 on Mar. 23, 2007, patented as U.S. Pat. No. 8,084,102 on Dec. 27, 2011, and entitled “METHODS FOR CO-FLASH EVAPORATION OF POLYMERIZABLE MONOMERS AND NON-POLYMERIZABLE CARRIER SOLVENT/SALT MIXTURES/SOLUTIONS”; U.S. Publication No. US-2011-0006738-A1 published on Jan. 13, 2011, filed as U.S. application Ser. No. 12/679,371 on Sep. 23, 2010, and entitled “ELECTROLYTE ADDITIVES FOR LITHIUM BATTERIES AND RELATED METHODS”; U.S. Publication No. US-2011-0008531-A1 published on Jan. 13, 2011, filed as U.S. application Ser. No. 12/811,576 on Sep. 23, 2010, patented as U.S. Pat. No. 9,034,421 on May 19, 2015, and entitled “METHODS OF FORMING ELECTRODES COMPRISING SULFUR AND POROUS MATERIAL COMPRISING CARBON”; U.S. Publication No. US-2010-0035128-A1 published on Feb. 11, 2010, filed as U.S. application Ser. No. 12/535,328 on Aug. 4, 2009, patented as U.S. Pat. No. 9,105,938 on Aug. 11, 2015, and entitled “APPLICATION OF FORCE IN ELECTROCHEMICAL CELLS”; U.S. Publication No. US-2011-0165471-A9 published on Jul. 15, 2011, filed as U.S. application Ser. No. 12/180,379 on Jul. 25, 2008, and entitled “PROTECTION OF ANODES FOR ELECTROCHEMICAL CELLS”; U.S. Publication No. US-2006-0222954-A1 published on Oct. 5, 2006, filed as U.S. application Ser. No. 11/452,445 on Jun. 13, 2006, patented as U.S. Pat. No. 8,415,054 on Apr. 9, 2013, and entitled “LITHIUM ANODES FOR ELECTROCHEMICAL CELLS”; U.S. Publication No. US-2010-0239914-A1 published on Sep. 23, 2010, filed as U.S. application Ser. No. 12/727,862 on Mar. 19, 2010, and entitled “CATHODE FOR LITHIUM BATTERY”; U.S. Publication No. US-2010-0294049-A1 published on Nov. 25, 2010, filed as U.S. application Ser. No. 12/471,095 on May 22, 2009, patented as U.S. Pat. No. 8,087,309 on Jan. 3, 2012, and entitled “HERMETIC SAMPLE HOLDER AND METHOD FOR PERFORMING MICROANALYSIS UNDER CONTROLLED ATMOSPHERE ENVIRONMENT”; U.S. Publication No. US-2011-0076560-A1 published on Mar. 31, 2011, filed as U.S. application Ser. No. 12/862,581 on Aug. 24, 2010, and entitled “ELECTROCHEMICAL CELLS COMPRISING POROUS STRUCTURES COMPRISING SULFUR”; U.S. Publication No. US-2011-0068001-A1 published on Mar. 24, 2011, filed as U.S. application Ser. No. 12/862,513 on Aug. 24, 2010, and entitled “RELEASE SYSTEM FOR ELECTROCHEMICAL CELLS”; U.S. Publication No. US-2012-0048729-A1 published on Mar. 1, 2012, filed as U.S. application Ser. No. 13/216,559 on Aug. 24, 2011, and entitled “ELECTRICALLY NON-CONDUCTIVE MATERIALS FOR ELECTROCHEMICAL CELLS”; U.S. Publication No. US-2011-0177398-A1 published on Jul. 21, 2011, filed as U.S. application Ser. No. 12/862,528 on Aug. 24, 2010, patented as U.S. Pat. No. 10,629,947 on Apr. 21, 2020, and entitled “ELECTROCHEMICAL CELL”; U.S. Publication No. US-2011-0070494-A1 published on Mar. 24, 2011, filed as U.S. application Ser. No. 12/862,563 on Aug. 24, 2010, and entitled “ELECTROCHEMICAL CELLS COMPRISING POROUS STRUCTURES COMPRISING SULFUR”; U.S. Publication No. US-2011-0070491-A1 published on Mar. 24, 2011, filed as U.S. application Ser. No. 12/862,551 on Aug. 24, 2010, and entitled “ELECTROCHEMICAL CELLS COMPRISING POROUS STRUCTURES COMPRISING SULFUR”; U.S. Publication No. US-2011-0059361-A1 published on Mar. 10, 2011, filed as U.S. application Ser. No. 12/862,576 on Aug. 24, 2010, patented as U.S. Pat. No. 9,005,809 on Apr. 14, 2015, and entitled “ELECTROCHEMICAL CELLS COMPRISING POROUS STRUCTURES COMPRISING SULFUR”; U.S. Publication No. US-2012-0052339-A1 published on Mar. 1, 2012, filed as U.S. application Ser. No. 13/216,579 on Aug. 24, 2011, and entitled “ELECTROLYTE MATERIALS FOR USE IN ELECTROCHEMICAL CELLS”; U.S. Publication No. US-2012-0070746-A1 published on Mar. 22, 2012, filed as U.S. Application Ser. No. 13/240,113 on Sep. 22, 2011, and entitled “LOW ELECTROLYTE ELECTROCHEMICAL CELLS”; U.S. Publication No. US-2011-0206992-A1 published on Aug. 25, 2011, filed as U.S. application Ser. No. 13/033,419 on Feb. 23, 2011, and entitled “POROUS STRUCTURES FOR ENERGY STORAGE DEVICES”; U.S. Publication No. US-2012-0082872-A1 published on Apr. 5, 2012, filed as U.S. application Ser. No. 13/249,605 on Sep. 30, 2011, and entitled “ADDITIVE FOR ELECTROLYTES”; U.S. Publication No. US-2012-0082901-A1 published on Apr. 5, 2012, filed as U.S. application Ser. No. 13/249,632 on Sep. 30, 2011, and entitled “LITHIUM-BASED ANODE WITH IONIC LIQUID POLYMER GEL”; U.S. Publication No. US-2013-0164635-A1 published on Jun. 27, 2013, filed as U.S. application Ser. No. 13/700,696 on Mar. 6, 2013, patented as U.S. Pat. No. 9,577,243 on Feb. 21, 2017, and entitled “USE OF EXPANDED GRAPHITE IN LITHIUM/SULPHUR BATTERIES”; U.S. Publication No. US-2013-0017441-A1 published on Jan. 17, 2013, filed as U.S. application Ser. No. 13/524,662 on Jun. 15, 2012, patented as U.S. Pat. No. 9,548,492 on Jan. 17, 2017, and entitled “PLATING TECHNIQUE FOR ELECTRODE”; U.S. Publication No. US-2013-0224601-A1 published on Aug. 29, 2013, filed as U.S. application Ser. No. 13/766,862 on Feb. 14, 2013, patented as U.S. Pat. No. 9,077,041 on Jul. 7, 2015, and entitled “ELECTRODE STRUCTURE FOR ELECTROCHEMICAL CELL”; U.S. Publication No. US-2013-0252103-A1 published on Sep. 26, 2013, filed as U.S. application Ser. No. 13/789,783 on Mar. 8, 2013, patented as U.S. Pat. No. 9,214,678 on Dec. 15, 2015, and entitled “POROUS SUPPORT STRUCTURES, ELECTRODES CONTAINING SAME, AND ASSOCIATED METHODS”; U.S. Publication No. US-2015-0287998-A1 published on Oct. 8, 2015, filed as U.S. application Ser. No. 14/743,304 on Jun. 18, 2015, patented as U.S. Pat. No. 9,577,267 on Feb. 21, 2017, and entitled “ELECTRODE STRUCTURE AND METHOD FOR MAKING SAME”; U.S. Publication No. US-2013-0095380-A1 published on Apr. 18, 2013, filed as U.S. application Ser. No. 13/644,933 on Oct. 4, 2012, patented as U.S. Pat. No. 8,936,870 on Jan. 20, 2015, and entitled “ELECTRODE STRUCTURE AND METHOD FOR MAKING THE SAME”; U.S. Publication No. US-2012-0052397-A1 published on Mar. 1, 2012, filed as U.S. application Ser. No. 13/216,538 on Aug. 24, 2011, patented as U.S. Pat. No. 9,853,287 on Dec. 26, 2017, and entitled “ELECTROLYTE MATERIALS FOR USE IN ELECTROCHEMICAL CELLS”; U.S. Publication No. US-2014-0123477-A1 published on May 8, 2014, filed as U.S. application Ser. No. 14/069,698 on Nov. 1, 2013, patented as U.S. Pat. No. 9,005,311 on Apr. 14, 2015, and entitled “ELECTRODE ACTIVE SURFACE PRETREATMENT”; U.S. Publication No. US-2014-0193723-A1 published on Jul. 10, 2014, filed as U.S. application Ser. No. 14/150,156 on Jan. 8, 2014, patented as U.S. Pat. No. 9,559,348 on Jan. 31, 2017, and entitled “CONDUCTIVITY CONTROL IN ELECTROCHEMICAL CELLS”; U.S. Publication No. US-2014-0255780-A1 published on Sep. 11, 2014, filed as U.S. application Ser. No. 14/197,782 on Mar. 5, 2014, patented as U.S. Pat. No. 9,490,478 on Nov. 8, 2016, and entitled “ELECTROCHEMICAL CELLS COMPRISING FIBRIL MATERIALS”; U.S. Publication No. US-2014-0272594-A1 published on Sep. 18, 2014, filed as U.S. application Ser. No. 13/833,377 on Mar. 15, 2013, and entitled “PROTECTIVE STRUCTURES FOR ELECTRODES”; U.S. Publication No. US-2014-0272597-A1 published on Sep. 18, 2014, filed as U.S. application Ser. No. 14/209,274 on Mar. 13, 2014, patented as U.S. Pat. No. 9,728,768 on Aug. 8, 2017, and entitled “PROTECTED ELECTRODE STRUCTURES AND METHODS”; U.S. Publication No. US-2015-0280277-A1 published on Oct. 1, 2015, filed as U.S. application Ser. No. 14/668,102 on Mar. 25, 2015, patented as U.S. Pat. No. 9,755,268 on Sep. 5, 2017, and entitled “GEL ELECTROLYTES AND ELECTRODES”; U.S. Publication No. US-2015-0180037-A1 published on Jun. 25, 2015, filed as U.S. application Ser. No. 14/576,570 on Dec. 19, 2014, patented as U.S. Pat. No. 10,020,512 on Jul. 10, 2018, and entitled “POLYMER FOR USE AS PROTECTIVE LAYERS AND OTHER COMPONENTS IN ELECTROCHEMICAL CELLS”; U.S. Publication No. US-2015-0349310-A1 published on Dec. 3, 2015, filed as U.S. application Ser. No. 14/723,132 on May 27, 2015, patented as U.S. Pat. No. 9,735,411 on Aug. 15, 2017, and entitled “POLYMER FOR USE AS PROTECTIVE LAYERS AND OTHER COMPONENTS IN ELECTROCHEMICAL CELLS”; U.S. Publication No. US-2014-0272595-A1 published on Sep. 18, 2014, filed as U.S. application Ser. No. 14/203,802 on Mar. 11, 2014, and entitled “COMPOSITIONS FOR USE AS PROTECTIVE LAYERS AND OTHER COMPONENTS IN ELECTROCHEMICAL CELLS”; U.S. Publication No. US-2019-0006699-A1 published on Jan. 3, 2019, filed as U.S. application Ser. No. 15/727,438 on Oct. 6, 2017, and entitled “PRESSURE AND/OR TEMPERATURE MANAGEMENT IN ELECTROCHEMICAL SYSTEMS”; U.S. Publication No. US-2014-0193713-A1 published on Jul. 10, 2014, filed as U.S. Application Ser. No. 14/150,196 on Jan. 8, 2014, patented as U.S. Pat. No. 9,531,009 on Dec. 27, 2016, and entitled “PASSIVATION OF ELECTRODES IN ELECTROCHEMICAL CELLS”; U.S. Publication No. US-2014-0127577-A1 published on May 8, 2014, filed as U.S. application Ser. No. 14/068,333 on Oct. 31, 2013, patented as U.S. Pat. No. 10,243,202 on Mar. 26, 2019, and entitled “POLYMERS FOR USE AS PROTECTIVE LAYERS AND OTHER COMPONENTS IN ELECTROCHEMICAL CELLS”; U.S. Publication No. US-2015-0318539-A1 published on Nov. 5, 2015, filed as U.S. application Ser. No. 14/700,258 on Apr. 30, 2015, patented as U.S. Pat. No. 9,711,784 on Jul. 18, 2017, and entitled “ELECTRODE FABRICATION METHODS AND ASSOCIATED SYSTEMS AND ARTICLES”; U.S. Publication No. US-2014-0272565-A1 published on Sep. 18, 2014, filed as U.S. application Ser. No. 14/209,396 on Mar. 13, 2014, patented as U.S. Pat. No. 10,862,105 on Dec. 8, 2020 and entitled “PROTECTED ELECTRODE STRUCTURES”; U.S. Publication No. US-2015-0010804-A1 published on Jan. 8, 2015, filed as U.S. application Ser. No. 14/323,269 on Jul. 3, 2014, patented as U.S. Pat. No. 9,994,959 on Jun. 12, 2018, and entitled “CERAMIC/POLYMER MATRIX FOR ELECTRODE PROTECTION IN ELECTROCHEMICAL CELLS, INCLUDING RECHARGEABLE LITHIUM BATTERIES”; U.S. Publication No. US-2015-0162586-A1 published on Jun. 11, 2015, filed as U.S. application Ser. No. 14/561,305 on Dec. 5, 2014, and entitled “NEW SEPARATOR”; U.S. Publication No. US-2015-0044517-A1 published on Feb. 12, 2015, filed as U.S. application Ser. No. 14/455,230 on Aug. 8, 2014, patented as U.S. Pat. No. 10,020,479 on Jul. 10, 2018, and entitled “SELF-HEALING ELECTRODE PROTECTION IN ELECTROCHEMICAL CELLS”; U.S. Publication No. US-2015-0236322-A1 published on Aug. 20, 2015, filed as U.S. application Ser. No. 14/184,037 on Feb. 19, 2014, patented as U.S. Pat. No. 10,490,796 on Nov. 26, 2019, and entitled “ELECTRODE PROTECTION USING ELECTROLYTE-INHIBITING ION CONDUCTOR”; U.S. Publication No. US-2015-0236320-A1 published on Aug. 20, 2015, filed as U.S. Application Ser. No. 14/624,641 on Feb. 18, 2015, patented as U.S. Pat. No. 9,653,750 on May 16, 2017, and entitled “ELECTRODE PROTECTION USING A COMPOSITE COMPRISING AN ELECTROLYTE-INHIBITING ION CONDUCTOR”; U.S. Publication No. US-2016-0118638-A1 published on Apr. 28, 2016, filed as U.S. application Ser. No. 14/921,381 on Oct. 23, 2015, and entitled “COMPOSITIONS FOR USE AS PROTECTIVE LAYERS AND OTHER COMPONENTS IN ELECTROCHEMICAL CELLS”; U.S. Publication No. US-2016-0118651-A1 published on Apr. 28, 2016, filed as U.S. application Ser. No. 14/918,672 on Oct. 21, 2015, and entitled “ION-CONDUCTIVE COMPOSITE FOR ELECTROCHEMICAL CELLS”; U.S. Publication No. US-2016-0072132-A1 published on Mar. 10, 2016, filed as U.S. Application Ser. No. 14/848,659 on Sep. 9, 2015, patented as U.S. Pat. No. 11,038,178 on Jun. 15, 2021 and entitled “PROTECTIVE LAYERS IN LITHIUM-ION ELECTROCHEMICAL CELLS AND ASSOCIATED ELECTRODES AND METHODS”; U.S. Publication No. US-2018-0138542-A1 published on May 17, 2018, filed as U.S. application Ser. No. 15/567,534 on Oct. 18, 2017, patented as U.S. Pat. No. 10,847,833 on Nov. 24, 2020 and entitled “GLASS-CERAMIC ELECTROLYTES FOR LITHIUM-SULFUR BATTERIES”; U.S. Publication No. US-2016-0344067-A1 published on Nov. 24, 2016, filed as U.S. application Ser. No. 15/160,191 on May 20, 2016, patented as U.S. Pat. No. 10,461,372 on Oct. 29, 2019, and entitled “PROTECTIVE LAYERS FOR ELECTROCHEMICAL CELLS”; U.S. Publication No. US-2020-0099108-A1 published on Mar. 26, 2020, filed as U.S. application Ser. No. 16/587,939 on Sep. 30, 2019, and entitled “PROTECTIVE LAYERS FOR ELECTROCHEMICAL CELLS”; U.S. Publication No. US-2017-0141385-A1 published on May 18, 2017, filed as U.S. application Ser. No. 15/343,890 on Nov. 4, 2016, and entitled “LAYER COMPOSITE AND ELECTRODE HAVING A SMOOTH SURFACE, AND ASSOCIATED METHODS”; U.S. Publication No. US-2017-0141442-A1 published on May 18, 2017, filed as U.S. application Ser. No. 15/349,140 on Nov. 11, 2016, and entitled “ADDITIVES FOR ELECTROCHEMICAL CELLS”; patented as U.S. patent Ser. No. 10/320,031 on Jun. 11, 2019, and entitled “ADDITIVES FOR ELECTROCHEMICAL CELLS”; U.S. Publication No. US-2017-0149086-A1 published on May 25, 2017, filed as U.S. application Ser. No. 15/343,635 on Nov. 4, 2016, patented as U.S. Pat. No. 9,825,328 on Nov. 21, 2017, and entitled “IONICALLY CONDUCTIVE COMPOUNDS AND RELATED USES”; U.S. Publication No. US-2018-0337406-A1 published on Nov. 22, 2018, filed as U.S. application Ser. No. 15/983,352 on May 18, 2018, patented as U.S. Pat. No. 10,868,306 on Dec. 15, 2020 and entitled “PASSIVATING AGENTS FOR ELECTROCHEMICAL CELLS”; U.S. Publication No. US-2018-0261820-A1 published on Sep. 13, 2018, filed as U.S. application Ser. No. 15/916,588 on Mar. 9, 2018, patented as U.S. Pat. No. 11,024,923 on Jun. 1, 2021 and entitled “ELECTROCHEMICAL CELLS COMPRISING SHORT-CIRCUIT RESISTANT ELECTRONICALLY INSULATING REGIONS”; U.S. Publication No. US-2020-0243824-A1 published on Jul. 30, 2020, filed as U.S. application Ser. No. 16/098,654 on Nov. 2, 2018, patented as U.S. Pat. No. 10,991,925 on Apr. 27, 2021 and entitled “COATINGS FOR COMPONENTS OF ELECTROCHEMICAL CELLS”; U.S. Publication No. US-2018-0351158-A1 published on Dec. 6, 2018, filed as U.S. application Ser. No. 15/983,363 on May 18, 2018, patented as U.S. Pat. No. 10,944,094 on Mar. 9, 2021 and entitled “PASSIVATING AGENTS FOR ELECTROCHEMICAL CELLS”; U.S. Publication No. US-2018-0277850-A1 published on Sep. 27, 2018, filed as U.S. application Ser. No. 15/923,342 on Mar. 16, 2018, and patented as U.S. Pat. No. 10,720,648 on Jul. 21, 2020, and entitled “ELECTRODE EDGE PROTECTION IN ELECTROCHEMICAL CELLS”; U.S. Publication No. US-2018-0358651-A1 published on Dec. 13, 2018, filed as U.S. application Ser. No. 16/002,097 on Jun. 7, 2018, and patented as U.S. Pat. No. 10,608,278 on Mar. 31, 2020, and entitled “IN SITU CURRENT COLLECTOR”; U.S. Publication No. US-2017-0338475-A1 published on Nov. 23, 2017, filed as U.S. application Ser. No. 15/599,595 on May 19, 2017, patented as U.S. Pat. No. 10,879,527 on Dec. 29, 2020, and entitled “PROTECTIVE LAYERS FOR ELECTRODES AND ELECTROCHEMICAL CELLS”; U.S. Publication No. US-2019-0088958-A1 published on Mar. 21, 2019, filed as U.S. application Ser. No. 16/124,384 on Sep. 7, 2018, and entitled “PROTECTIVE MEMBRANE FOR ELECTROCHEMICAL CELLS”; U.S. Publication No. US-2019-0348672-A1 published on Nov. 14, 2019, filed as U.S. application Ser. No. 16/470,708 on Jun. 18, 2019. patented as U.S. Pat. No. 11,183,690 on Nov. 23, 2021, and entitled “PROTECTIVE LAYERS COMPRISING METALS FOR ELECTROCHEMICAL CELLS”; U.S. Publication No. US-2017-0200975-A1 published Jul. 13, 2017, filed as U.S. application Ser. No. 15/429,439 on Feb. 10, 2017, and patented as U.S. Pat. No. 10,050,308 on Aug. 14, 2018, and entitled “LITHIUM-ION ELECTROCHEMICAL CELL, COMPONENTS THEREOF, AND METHODS OF MAKING AND USING SAME”; U.S. Publication No. US-2018-0351148-A1 published Dec. 6, 2018, filed as U.S. Application Ser. No. 15/988,182 on May 24, 2018, patented as U.S. Pat. No. 11,251,501 on Feb. 15, 2022, and entitled “IONICALLY CONDUCTIVE COMPOUNDS AND RELATED USES”; U.S. Publication No. US-2018-0254516-A1 published Sep. 6, 2018, filed as U.S. application Ser. No. 15/765,362 on Apr. 2, 2018, and entitled “NON-AQUEOUS ELECTROLYTES FOR HIGH ENERGY LITHIUM-ION BATTERIES”; U.S. Publication No. US-2020-0044460-A1 published Feb. 6, 2020, patented as U.S. Pat. No. 11,489,348 on Nov. 1, 2022, filed as U.S. application Ser. No. 16/527,903 on Jul. 31, 2019, and entitled “MULTIPLEXED CHARGE DISCHARGE BATTERY MANAGEMENT SYSTEM”; U.S. Publication No. US-2020-0220146-A1 published Jul. 9, 2020, patented as U.S. Pat. No. 11,322,804 on May 3, 2022, filed as U.S. application Ser. No. 16/724,586 on Dec. 23, 2019, and entitled “ISOLATABLE ELECTRODES AND ASSOCIATED ARTICLES AND METHODS”; U.S. Publication No. US-2020-0220149-A1 published Jul. 9, 2020, filed as U.S. application Ser. No. 16/724,596 on Dec. 23, 2019, and entitled “ELECTRODES, HEATERS, SENSORS, AND ASSOCIATED ARTICLES AND METHODS”; U.S. Publication No. US-2020-0220197-A1 published Jul. 9, 2020, filed as U.S. application Ser. No. 16/724,612 on Dec. 23, 2019, and entitled “FOLDED ELECTROCHEMICAL DEVICES AND ASSOCIATED METHODS AND SYSTEMS”, U.S. Publication No. US-2020-0373578-A1 published Nov. 26, 2020, filed as U.S. application Ser. No. 16/879,861 on May 21, 2020, and entitled “ELECTROCHEMICAL DEVICES INCLUDING POROUS LAYERS”, U.S. Publication No. US-2020-0373551-A1 published Nov. 26, 2020, filed as U.S. application Ser. No. 16/879,839 on May 21, 2020, and entitled “ELECTRICALLY COUPLED ELECTRODES, AND ASSOCIATED ARTICLES AND METHODS”, U.S. Publication No. US-2020-0395585-A1 published Dec. 17, 2020, filed as U.S. application Ser. No. 16/057,050 on Aug. 7, 2018, and entitled “LITHIUM-COATED SEPARATORS AND ELECTROCHEMICAL CELLS COMPRISING THE SAME”, U.S. Publication No. US-2021-0057753-A1 published Feb. 25, 2021, filed as U.S. application Ser. No. 16/994,006 on Aug. 14, 2020, and entitled “ELECTROCHEMICAL CELLS AND COMPONENTS COMPRISING THIOL GROUP-CONTAINING SPECIES”, U.S. Publication No. US-2021-0135297-A1 published on May 6, 2021, patented as U.S. Pat. No. 11,424,492 on Aug. 23, 2022, filed as U.S. application Ser. No. 16/670,905 on Oct. 31, 2019, and entitled SYSTEM AND METHOD FOR OPERATING A RECHARGEABLE ELECTROCHEMICAL CELL OR BATTERY″, U.S. Publication No. US-2021-0138673-A1 published on May 13, 2021, filed as U.S. application Ser. No. 17/089,092 on Nov. 4, 2020, and entitled “ELECTRODE CUTTING INSTRUMENT”, U.S. Publication No. US-2021-0135294-A1 published on May 6, 2021, filed as U.S. application Ser. No. 16/670,933 on Oct. 31, 2019, patented as U.S. Pat. No. 11,056,728 on Jul. 6, 2021 and entitled “SYSTEM AND METHOD FOR OPERATING A RECHARGEABLE ELECTROCHEMICAL CELL OR BATTERY”; U.S. Publication No. US-2021-0151839-A1 published on May 20, 2021, filed as U.S. Application Ser. No. 16/952,177 on Nov. 19, 2020, and entitled “BATTERIES, AND ASSOCIATED SYSTEMS AND METHODS”; U.S. Publication No. US-2021-0151830-A1 published on May 20, 2021, filed as U.S. application Ser. No. 16/952,235 on Nov. 19, 2020, and entitled “BATTERIES WITH COMPONENTS INCLUDING CARBON FIBER, AND ASSOCIATED SYSTEMS AND METHODS”; U.S. Publication No. US-2021-0151817-A1 published on May 20, 2021, filed as U.S. application Ser. No. 16/952,228 on Nov. 19, 2020, and entitled “BATTERY ALIGNMENT, AND ASSOCIATED SYSTEMS AND METHODS”; U.S. Publication No. US-2021-0151841-A1 published on May 20, 2021, filed as U.S. application Ser. No. 16/952,240 on Nov. 19, 2020, and entitled “SYSTEMS AND METHODS FOR APPLYING AND MAINTAINING COMPRESSION PRESSURE ON ELECTROCHEMICAL CELLS”; U.S. Publication No. US-2021-0151816-A1 published on May 20, 2021, filed as U.S. application Ser. No. 16/952,223 on Nov. 19, 2020, and entitled “THERMALLY INSULATING COMPRESSIBLE COMPONENTS FOR BATTERY PACKS”; U.S. Publication No. US-2021-0151840-A1 published on May 20, 2021, filed as U.S. Application Ser. No. 16/952,187 on Nov. 19, 2020, and entitled “COMPRESSION SYSTEMS FOR BATTERIES”; U.S. Publication No. US-2021-0193984-A1 published on Jun. 24, 2021, filed as U.S. application Ser. No. 17/125,124 on Dec. 17, 2020, and entitled “SYSTEMS AND METHODS FOR FABRICATING LITHIUM METAL ELECTRODES”; U.S. Publication No. US-2021-0193985-A1 published on Jun. 24, 2021, filed as U.S. application Ser. No. 17/125,110 on Dec. 17, 2020, and entitled “LITHIUM METAL ELECTRODES AND METHODS”; U.S. Publication No. US-2021-0193996-A1 published on Jun. 24, 2021, filed as U.S. application Ser. No. 17/125,070 on Dec. 17, 2020, and entitled “LITHIUM METAL ELECTRODES”; U.S. Publication No. US-2021-0194069-A1 published on Jun. 24, 2021, filed as U.S. application Ser. No. 17/126,390 on Dec. 18, 2020, and entitled “SYSTEMS AND METHODS FOR PROVIDING, ASSEMBLING, AND MANAGING INTEGRATED POWER BUS FOR RECHARGEABLE ELECTROCHEMICAL CELL OR BATTERY”; U.S. Publication No. US-2021-0218243 published on Jul. 15, 2021, filed as U.S. application Ser. No. 17/126,424 on Dec. 18, 2020, and entitled “SYSTEMS AND METHODS FOR PROTECTING A CIRCUIT, RECHARGEABLE ELECTROCHEMICAL CELL, OR BATTERY”; U.S. Publication No. 2022-0069593 published on Mar. 3, 2022, filed as U.S. application Ser. No. 17/463,467 filed on Aug. 31, 2021, and entitled “Multiplexed Battery Management System”; U.S. Publication No. 2022-0048121 published on Feb. 17, 2022, filed as U.S. application Ser. No. 17/397,114 filed on Aug. 9, 2021, and entitled “Ultrasonic Blade for Cutting a Metal”, U.S. Publication No. 2022-0115715 published on Apr. 14, 2022, filed as U.S. application Ser. No. 17/479,299 filed on Sep. 20, 2021 and entitled “Electrolytes for Reduced Gassing”; U.S. Publication No. 2022-0359902 published on Nov. 10, 2022, filed as U.S. application Ser. No. 17/621,409 filed on Dec. 21, 2021, and entitled “METHODS, SYSTEMS, AND DEVICES FOR APPLYING FORCES TO ELECTROCHEMICAL DEVICES”; U.S. Publication No. 2022-0352521 published on Nov. 3, 2022, filed as U.S. application Ser. No. 17/730,792 on Apr. 27, 2022, and entitled “INTEGRATED BATTERY ELECTRODE AND SEPARATOR”; U.S. Publication No. 2022-0336872 published on Oct. 20, 2022, filed as U.S. application Ser. No. 17/592,406 on Feb. 3, 2022, and entitled “CHARGE/DISCHARGE MANAGEMENT IN ELECTROCHEMICAL CELLS, INCLUDING PARTIAL CYCLE CONTROL”; U.S. Publication No. 2022-0328880 published on Oct. 13, 2022, filed as U.S. application Ser. No. 17/712,754 on Apr. 4, 2022, and entitled “ELECTROLYTES FOR LITHIUM BATTERIES”; U.S. Publication No. 2022-0320586 published on Oct. 6, 2022, filed as U.S. application Ser. No. 17/703,415 on Mar. 24, 2022, and entitled “IN-SITU CONTROL OF SOLID ELECTROLYTE INTERFACE FOR ENHANCED CYCLE PERFORMANCE IN LITHIUM METAL BATTERIES”; U.S. Publication No. 2022-0311081 published on Sep. 29, 2022, filed as U.S. application Ser. No. 17/702,971 on Mar. 24, 2022, and entitled “BATTERY PACK AND RELATED COMPONENTS AND METHODS”; U.S. Publication No. 2022-0271537 published on Aug. 25, 2022, filed as U.S. application Ser. No. 17/592,398 on Feb. 3, 2022, and entitled “CHARGE/DISCHARGE MANAGEMENT IN ELECTROCHEMICAL CELLS, INCLUDING PARTIAL CYCLE CONTROL”; U.S. Publication No. 2022-0209327 published on Jun. 30, 2022, filed as U.S. application Ser. No. 17/565,317 on Dec. 29, 2021, and entitled “TEMPERATURE MANAGEMENT FOR ELECTROCHEMICAL CELLS”; U.S. Publication No. 2022-0199968 published on Jun. 23, 2022, filed as U.S. application Ser. No. 17/552,829 on Dec. 16, 2021, and entitled “LASER CUTTING OF COMPONENTS FOR ELECTROCHEMICAL CELLS”; U.S. Publication No. 2022-0181624 published on Jun. 9, 2022, filed as U.S. application Ser. No. 17/540,611 on Dec. 2, 2021, and entitled “LOW POROSITY ELECTRODES AND RELATED METHODS”; U.S. Publication No. 2022-0181624 published on Jun. 9, 2022, filed as U.S. application Ser. No. 17/492,084 on Oct. 1, 2021, and entitled “ELECTROCHEMICAL CELLS COMPRISING NITROGEN-CONTAINING SPECIES, AND METHODS OF FORMING THEM”; U.S. Publication No. 2023-0006185 published on Jan. 5, 2023, filed as U.S. application Ser. No. 17/849,890 on Jun. 27, 2022, and entitled “Systems and Methods for Roll to Roll Deposition of Electrochemical Cell Components and Other Articles”; U.S. Publication No. 2022-0407127 published on Dec. 22, 2022, filed as U.S. application Ser. No. 17/849,814 on Jun. 27, 2022, and entitled “System and Method for Operating a Rechargeable Electrochemical Cell or Battery”.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “cither,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, “wt %” is an abbreviation of weight percentage. As used herein, “at %” is an abbreviation of atomic percentage.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. An electrochemical cell management system comprising:
two or more electrochemical cell sets;
a multiplexing switch apparatus; and
at least one controller configured to:
compare a power demand to a threshold power demand; and
in response to determining that the power demand is below the threshold power demand, use the multiplexing switch apparatus to selectively discharge the electrochemical cell sets.

2. The electrochemical cell management system of claim 1, wherein the controller is further configured to, in response to determining that the power demand is at or above the threshold power demand, discharge the electrochemical cell sets without multiplexing.

3. The electrochemical cell management system of claim 1,
wherein the at least one controller is configured to receive the power demand.

4. The electrochemical cell management system of claim 3,
wherein the power demand is received from a vehicle connected to the electrochemical cell sets in response to an acceleration request to the vehicle.

5. The electrochemical cell management system of claim 1,
wherein the at least one controller is configured to monitor power demand over an interval of time, and the power demand comprises an average power demand over the interval of time.

6. The electrochemical cell management system of claim 5,
wherein the interval of time is between 1 second and 10 seconds.

7. The electrochemical cell management system of claim 1,
wherein each electrochemical cell set comprises a single cell.

8. An electrochemical cell management method comprising:
comparing a power demand of a system comprising two or more electrochemical cell sets to a threshold power demand; and
in response to determining that the power demand is below the threshold power demand, using a multiplexing switch apparatus to selectively discharge the electrochemical cell sets.

9. The electrochemical cell management method of claim 8, further comprising, in response to determining that the power demand is at or above the threshold power demand, discharging the electrochemical cell sets without multiplexing.

10. The electrochemical cell management method of claim 8,
further comprising receiving the power demand.

11. The electrochemical cell management method of claim 10,
wherein the power demand is received from a vehicle connected to the electrochemical cell sets by a controller of the electrochemical cell sets in response to an acceleration request to the vehicle.

12. The electrochemical cell management method of claim 8,
further comprising monitoring power demand over an interval of time, wherein the power demand comprises an average power demand over the interval of time.

13. The electrochemical cell management method of claim 12,
wherein the interval of time is between 1 second and 10 seconds.

14. The electrochemical cell management method of claim 8,
wherein each electrochemical cell set comprises a single cell.
